(19) United States
(12) Patent Application Publication
(10) Pub. No.: US 2019/0130361 A1
(43) Pub. Date: May 2, 2019

(54) METHOD FOR RENDERING HUMAN TALENT MANAGEMENT-AS-A-SERVICE (HTMAAS) IN CLOUD COMPUTING BASED HUMAN TALENT MANAGEMENT SYSTEM

(71) Applicants: Monangku HAZARIKA, Bangalore (IN); Nagaraja SHIVASHANKAR, San Diego, CA (US)

(72) Inventors: Monangku HAZARIKA, Bangalore (IN); Nagaraja SHIVASHANKAR, San Diego, CA (US)

(21) Appl. No.: 15/810,008

(22) Filed: Nov. 11, 2017

(30) Foreign Application Priority Data
Oct. 26, 2017 (IN) 201741037885

(51) Int. Cl. G06Q 10/10; G06Q 10/06

(52) U.S. Cl. CPC G06Q 10/1053; G06Q 10/0637; G06Q 10/063112

(57) ABSTRACT

Embodiments of the present invention disclose a method facilitating subscription-based licensing and delivery of a secure proprietary client-server Service-Oriented Architecture-based Human Talent Management-As-A-Service (SOAHTMAAS) modular application software for rendering human talent management services. The method comprises remotely registering at least a user attempting to subscribe to the secure proprietary client-server SOAHTMAAS modular application software as at least one of a potential candidate, employer and crowdsourced Third-Party Subject Matter Expert (3PSME), and a combination thereof, as at least one of a new interviewee, interviewer subscriber, and a combination thereof, using at least a cloud client, for creation of at least one of a free and paid basic subscription-based membership account conditionally against at least one of nonpayment and payment of at least one of basic one-time and periodic subscription fee, facilitating standard Authenticated, Authorized and Accounted (AAA) access thereto for availing one or more services limited by way of at least one of features, capacity, use license, use time and support and rendered under basic services, and at least one of subsequent on-demand conditionally free and paid AAA access thereto for availing one or more unlimited services rendered under at least one of freemium and premium services to correspondingly use the secure proprietary client-server SOAHTMAAS modular application software, running on a cloud server hosting an online marketplace offering the secure proprietary client-server SOAHTMAAS modular application software, at least one of free and against payment of at least one of one-time and periodic subscription fee charged at least one of in part and entirety by at least one of an online marketplace operator, Third-Party Application Service Provider (3PASP), Third-Party Software Service Provider (3PSSP), Third-Party Application Software Service Provider (3PASSP), and a combination thereof, at least one of correspondingly managing the online marketplace, trading therein, and a combination thereof, upon successful registration, issuing unique user log-in credentials, such as a User Identifier (User ID) and Password (PWD), from the cloud server to each of the at least one of interviewee, interviewer subscriber, and combination thereof, for facilitating subsequent standard AAA access to the at least one of free and paid basic subscription-based membership account to limitedly use the secure proprietary client-server SOAHTMAAS application software and at least one of subsequent on-demand conditionally free and paid access to unlimitedly use the secure proprietary client-server SOAHTMAAS modular application software, upon later access as a return user, securely Authenticating, Authorizing and Accounting (AAA) each of the at least one of interviewee, interviewer subscriber, and combination thereof, via usage of an AAA engine of the cloud server, thereby facilitating managing access to the at least one of basic access and minimal service subscription-based account rendered as the basic service and at least one of subsequent conditionally free and paid access to use the secure proprietary client-server HTMAAS application software rendered as the at least one of freemium and premium service, upon successful AAA, at least one of fully autonomously and automatically, searching and recommending at least one of most relevant, optimal and best potential jobs, subject to comparative analyses of the overall profiles of the potential candidates, comprising at least one of academic, professional credentials, Knowledge, Skills, and Abilities (KSA), skillsets, optional experience, endorsements, recommendations and referrals of the potential candidates, vis-à-vis corresponding potential jobs, and the at least one of job descriptions, requirements and specifications, as well as at least one of requested, required, expected, demanded and desired profiles, qualifications, experience, logistics, roles, responsibilities and skillset thereof, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), upon at least one of request and demand, subjecting the potential candidates to at least one of unbiased genuine and mock Third-Party (3P) pre-assessments comprising at least one of partially and fully, at least one of autonomously and automatically, searching and recommending at least one of most relevant, optimal and best potential 3PSMEs based partly on the analyses of the at least one of i) the overall profiles of the potential 3PSMEs comprising at least one of academic, professional credentials, Knowledge, Skills, and Abilities (KSA), skillsets, experience, ratings, feedbacks, comments, reviews, endorsements, recommendations and referrals of the potential 3PSMEs, ii) the overall profiles of the potential candidates, and the degree of match therebetween, for instance 3PSME-candidate fit most strongly related to 3PSME-oriented outcomes like 3PSME satisfaction, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), at least one of partially manually, autonomously and automatically pre-assessing the potential candidates, and combinations thereof, comprising pre-assessing the potential candidates via at least one of i) implementation of at least one of AI- and ML-based chatbots, and a combination thereof, and ii) at least one of partially manually selected, AI-, ML-searched-cum-recommended at least one of most optimal and best 3PSMEs, and a combination thereof, wherein the pre-assessment of the potential candidates via selectively engaging the at least one of partially manually selected, AI-, ML-searched-cum-recommended at least one of most optimal and best 3PSMEs, and combination thereof, comprising at least one of ethically, permissibly, selectively securely, accurately, legitimately and legibly capturing, recording, archiving and storing the contents of the at least one of partially manual, AI-, ML-based pre-assessment of the potential candidates, for instance at least one of offline face-to-face and online unbiased mock job interviews, by the 3PSMEs for subsequent use and reuse, whilst maintaining the at least one of pseudonymity and anonymity of the 3PSMEs, whereas the pre-assessment of the potential candidates via the implementation of the at least one of AI- and ML-based chatbots, and combination thereof, comprises analyzing the potential jobs, and the at least one of job descriptions, requirements and specifications, as well as at least one of requested, required, expected, demanded and desired profiles, qualifications, experience, logistics, roles, responsibilities and skillset thereof, posting questionnaires to the potential candidates, at least one of ethically, permissibly, selectively securely, accurately, legitimately and legibly capturing, recording, archiving, storing and processing the responses of the potential candidates using at least one of Artificial Intelligence (AI)-, Machine-Learning (ML)-based algorithms, and a combination thereof, searching and recommending at least one of most optimal and best responses to the questionnaires and the corresponding respondents, for instance the one or more pre-assessed candidates using at least one of AI-, ML-based search-cum-recommendation, and a combination thereof, at least one of adaptively and dynamically, at least one of iteratively reviewing and rating the pre-assessed candidates and adding the at least one of posted questionnaires, processed recorded responses, corresponding respondents thereto, and the reviews as well as ratings thereof and upon pre-assessment, reassessing the pre-assessed candidates by one or more potential employers comprising at least one of partially manually, autonomously and automatically, searching and recommending at least one of most relevant, optimal and best pre-assessed candidates for the at least one of most optimal, relevant and best potential jobs comprising at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers, and at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween.

### BACKGROUND OF THE INVENTION

### Field of the Invention

Embodiments of the present invention relate to human talent management systems and methods thereof, and more particularly, to improved method for unbiased Artificial Intelligence (AI)-, Machine Learning (ML)-based pre-assessment, screening, testing, interview, selection, background verification, hiring and on-boarding of the potential candidates, and combinations thereof, in cloud computing based human talent management system, thereby facilitating at least one of minimizing and reducing the at least one of time-to-hire, cost-to-hire, labor-to-hire, and a combination thereof.

### Description of the Related Art

Finding and hiring employees is a task that impacts most modern businesses. It is important for an employer to find employees that “fit” open positions. Criteria for fitting an open position may include skills necessary to perform job functions. Employers may also want to evaluate potential employees for mental and emotional stability, ability to work well with others, ability to assume leadership roles, ambition, attention to detail, problem solving, personality, etc.

However, the processes associated with finding employees can be expensive and time consuming for an employer. Such processes can include evaluating resumes and cover letters, telephone interviews with candidates, in-person interviews with candidates, drug testing, skill testing, sending rejection letters, offer negotiation, training new employees, etc. A single employee candidate can be very costly in terms of man-hours needed to evaluate and interact with the candidate before the candidate is hired.

Computers and computing systems can be used to automate some of these activities. For example, many businesses now have on-line recruiting tools that facilitate job postings, resume submissions, preliminary evaluations, etc. Additionally, some computing systems include functionality for allowing candidates to participate in “virtual” on-line interviews.

While computing tools have automated interview response gathering, there is still a lot of effort spent in evaluating responses. Often, respondents may be evaluated individually and ranked in the aggregate while side-by-side comparisons of specifics for different candidates may be difficult. For example, an evaluator, to compare specific answers of interviewees side by side, would need to search through stored responses for one candidate, access responses for another candidate, and search through the responses for the other candidate to find corresponding data needed for comparisons.

The job of interviewers and candidate reviewers is to determine if candidates are skilled and have the qualifications required for a particular job. In the process of doing this, they compare and contrast the qualifications of candidates often reviewing and comparing candidate responses to particular questions or tasks. As noted, the comparison process is often difficult as interviews are reviewed linearly (from beginning to end) and comparing responses for each candidate to a specific question is tedious and requires reordering and cross comparing. The result is that responses are often not evaluated equally, fairly or in light of other candidate responses.

Evaluation of candidates can be a very subjective process that is highly dependent on individual interviewers. However, large organizations may wish to remove or minimize subjectivity to maximize recruiting efforts, avoid charges of discrimination, or for other reasons. Various schemes exist to this end, but each of these schemes approaches the solution in different ways. Thus, an employer that makes a commitment to a provider of an automated interview and/or evaluation system is often constrained to that provider's solution.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF THE INVENTION

Embodiments of the present invention disclose a method facilitating subscription-based licensing and delivery of a secure proprietary client-server Service-Oriented Architecture-based Human Talent Management-As-A-Service (SOAHTMAAS) modular application software for rendering human talent management services. The method comprises remotely registering at least a user attempting to subscribe to the secure proprietary client-server SOAHTMAAS modular application software as at least one of a potential candidate, employer and crowdsourced Third-Party Subject Matter Expert (3PSME), and a combination thereof, as at least one of a new interviewee, interviewer subscriber, and a combination thereof, using at least a cloud client, for creation of at least one of a free and paid basic subscription-based membership account conditionally against at least one of nonpayment and payment of at least one of basic one-time and periodic subscription fee, facilitating standard Authenticated, Authorized and Accounted (AAA) access thereto for availing one or more services limited by way of at least one of features, capacity, use license, use time and support and rendered under basic services, and at least one of subsequent on-demand conditionally free and paid AAA access thereto for availing one or more unlimited services rendered under at least one of freemium and premium services to correspondingly use the secure proprietary client-server SOAHTMAAS modular application software, running on a cloud server hosting an online marketplace offering the secure proprietary client-server SOAHTMAAS modular application software, at least one of free and against payment of at least one of one-time and periodic subscription fee charged at least one of in part and entirety by at least one of an online marketplace operator, Third-Party Application Service Provider (3PASP), Third-Party Software Service Provider (3PSSP), Third-Party Application Software Service Provider (3PASSP), and a combination thereof, at least one of correspondingly managing the online marketplace, trading therein, and a combination thereof, upon successful registration, issuing unique user log-in credentials, such as a User Identifier (User ID) and Password (PWD), from the cloud server to each of the at least one of interviewee, interviewer subscriber, and combination thereof, for facilitating subsequent standard AAA access to the at least one of free and paid basic subscription-based membership account to limitedly use the secure proprietary client-server SOAHTMAAS application software and at least one of subsequent on-demand conditionally free and paid access to unlimitedly use the secure proprietary client-server SOAHTMAAS modular application software, upon later access as a return user, securely Authenticating, Authorizing and Accounting (AAA) each of the at least one of interviewee, interviewer subscriber, and combination thereof, via usage of an AAA engine of the cloud server, thereby facilitating managing access to the at least one of basic access and minimal service subscription-based account rendered as the basic service and at least one of subsequent conditionally free and paid access to use the secure proprietary client-server SOAHTMAAS application software rendered as the at least one of freemium and premium service, upon successful AAA, at least one of fully autonomously and automatically, searching and recommending at least one of most relevant, optimal and best potential jobs, subject to comparative analyses of the overall profiles of the potential candidates, comprising at least one of academic, professional credentials, Knowledge, Skills, and Abilities (KSA), skillsets, optional experience, endorsements, recommendations and referrals of the potential candidates, vis-à-vis corresponding potential jobs, and the at least one of job descriptions, requirements and specifications, as well as at least one of requested, required, expected, demanded and desired profiles, qualifications, experience, logistics, roles, responsibilities and skillset thereof, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), upon at least one of request and demand, subjecting the potential candidates to at least one of unbiased genuine and mock Third-Party (3P) pre-assessments comprising at least one of partially and fully, at least one of autonomously and automatically, searching and recommending at least one of most relevant, optimal and best potential 3PSMEs based partly on the analyses of the at least one of i) the overall profiles of the potential 3PSMEs comprising at least one of academic, professional credentials, Knowledge, Skills, and Abilities (KSA), skillsets, experience, ratings, feedbacks, comments, reviews, endorsements, recommendations and referrals of the potential 3PSMEs, ii) the overall profiles of the potential candidates, and the degree of match therebetween, for instance 3PSME-candidate fit most strongly related to 3PSME-oriented outcomes like 3PSME satisfaction, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), at least one of partially manually, autonomously and automatically pre-assessing the potential candidates, and combinations thereof, comprising pre-assessing the potential candidates via at least one of i) implementation of at least one of AI- and ML-based chatbots, and a combination thereof, and ii) at least one of partially manually selected, AI-, ML-searched-cum-recommended at least one of most optimal and best 3PSMEs, and a combination thereof, wherein the pre-assessment of the potential candidates via selectively engaging the at least one of partially manually selected, AI-, ML-searched-cum-recommended at least one of most optimal and best 3PSMEs, and combination thereof, comprising at least one of ethically, permissibly, selectively securely, accurately, legitimately and legibly capturing, recording, archiving and storing the contents of the at least one of partially manual, AI-, ML-based pre-assessment of the potential candidates, for instance at least one of offline face-to-face and online unbiased mock job interviews, by the 3PSMEs for subsequent use and reuse, whilst maintaining the at least one of pseudonymity and anonymity of the 3PSMEs, whereas the pre-assessment of the potential candidates via the implementation of the at least one of AI- and ML-based chatbots, and combination thereof, comprises analyzing the potential jobs, and the at least one of job descriptions, requirements and specifications, as well as at least one of requested, required, expected, demanded and desired profiles, qualifications, experience, logistics, roles, responsibilities and skillset thereof, posting questionnaires to the potential candidates, at least one of ethically, permissibly, selectively securely, accurately, legitimately and legibly capturing, recording, archiving, storing and processing the responses of the potential candidates using at least one of Artificial Intelligence (AI)-, Machine-Learning (ML)-based algorithms, and a combination thereof, searching and recommending at least one of most optimal and best responses to the questionnaires and the corresponding respondents, for instance the one or more pre-assessed candidates using at least one of AI-, ML-based search-cum-recommendation, and a combination thereof, at least one of adaptively and dynamically, at least one of iteratively reviewing and rating the pre-assessed candidates and adding the at least one of posted questionnaires, processed recorded responses, corresponding respondents thereto, and the reviews as well as ratings thereof and upon pre-assessment, reassessing the pre-assessed candidates by one or more potential employers comprising at least one of partially manually, autonomously and automatically, searching and recommending at least one of most relevant, optimal and best pre-assessed candidates for the at least one of most optimal, relevant and best potential jobs comprising at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers, and at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of the cloud computing based human talent management system facilitating providing overall human talent management services via licensing and delivery of the method for rendering Human Talent Management-As-A-Service (HTMAAS) comprising 1) at least one of partially manual, AI-, ML-based pre-assessment of the potential candidates, and combinations thereof, in turn, comprising at least one of i) pre-assessment of the potential candidates via implementation of at least one of AI- and ML-based chatbots and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby cooperatively facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, according to one or more embodiments;

FIGS. 2A-B depict the method for rendering Human Talent Management-As-A-Service (HTMAAS) in cloud computing based human talent management system, according to one or more embodiments; and

FIG. 3 depicts a computer system that may be a computing device and may be utilized in various embodiments of the present invention.

While the method and system is described herein by way of example for several embodiments and illustrative drawings, those skilled in the art will recognize that the method for rendering Human Talent Management-As-A-Service (HTMAAS) in cloud computing based human talent management system, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method for rendering Human Talent Management-As-A-Service (HTMAAS) in cloud computing based human talent management system defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of the present invention disclose methods for rendering Human Talent Management-As-A-Service (HTMAAS) in cloud computing based human talent management systems, thereby facilitating at least one of minimizing and reducing the at least one of time-to-hire, cost-to-hire, labor-to-hire, and a combination thereof, in accordance with the principles of the present invention. In the following detailed description, numerous specific details are set forth to provide a thorough understanding of claimed subject matter. However, it will be understood by those skilled in the art that claimed subject matter may be practiced without these specific details.

In some general embodiments, one or more methods and systems facilitating rendering Human Talent Management-As-A-Service (HTMAAS) are disclosed, in accordance with the principles of the present invention.

In some specific embodiments, design and implementation of the cloud computing based human talent management system, and at least one method thereof, for rendering Human Talent Management-As-A-Service (HTMAAS) comprising inter alia at least one of improved unbiased Artificial Intelligence (AI)-, Machine Learning (ML)-based pre-assessment, screening, testing, interview, selection, background verification, hiring and on-boarding of the potential candidates, and combinations thereof, thereby facilitating at least one of minimizing and reducing the at least one of time-to-hire, cost-to-hire, labor-to-hire, and a combination thereof, is disclosed, in accordance with the principles of the present invention.

In some detailed embodiments involving deployment of the cloud computing based human talent management system, the at least one method for rendering Human Talent Management-As-A-Service (HTMAAS) may comprise 1) at least one of partially manual, AI-, ML-based pre-assessment of the potential candidates, and combinations thereof, in turn, comprising at least one of i) pre-assessment of the potential candidates via implementation of at least one of AI- and ML-based chatbots and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, in accordance with the principles of the present invention.

In some practical embodiments, the cloud computing based human talent management system, and at least one method thereof, for cooperatively rendering Human Talent Management-As-A-Service (HTMAAS) may facilitate in filling the gaps by virtue of the Physical Points-of-Presence (PoPs) and distances of separation between the potential employers and candidates, in accordance with the principles of the present invention.

In some broad embodiments involving deployment of the cloud computing based human talent management system, the at least one method for rendering Human Talent Management-As-A-Service (HTMAAS) may comprise:

i) selectively capturing and aggregating at least one of biographical, biological, physiological, credential, identification data (or information), and combinations thereof, voluntarily submitted by at least one of potential candidates, job applicants, job aspirants, job seekers, trainees, interns, apprentices, freshers and jobless;

ii) selectively capturing and aggregating at least one of biographical, biological, physiological, credential, identification data (or information), and combinations thereof, voluntarily submitted by at least one of potential 3PSMEs, interviewers, professional assessors and experienced amateur assessors crowdsourced by one or more host (or hosting) service(s) aggregators;

iii) upon at least one of request and demand, subjecting the at least one of potential candidates, job applicants, job aspirants, job seekers, trainees, interns, apprentices, freshers and jobless to at least one of unbiased genuine and mock Third-Party (3P) evaluations (or pre-assessments), for instance at least one of eligibility, trainability, employability, sustainability assessments, and combinations thereof, comprising inter alia facilitating the at least one of potential 3PSMEs, interviewers, professional assessors and experienced amateur assessors in interviewing the at least one of potential candidates, job applicants, job aspirants, job seekers, trainees, interns, apprentices, freshers and jobless against at least one of corresponding potential job positions, offers and jobs, and the at least one of corresponding job descriptions, requirements and specifications, as well as at least one of requested, required, expected, demanded and desired profiles, qualifications, experience, logistics, roles, responsibilities and skillset thereof, via conducting at least one of employment and job interviews hosted by the one or more host (or hosting) service(s) aggregators, whilst maintaining at least one of pseudonymity and anonymity of the at least one of potential third-party subject matter experts, interviewers, professional assessors; and

iv) re-subjecting the at least one of pre-assessed candidates, job applicants, job aspirants, job seekers, trainees, interns, apprentices, freshers and jobless for one or more genuine assessments by at least one of potential employers, companies, job providers, hirers, organizations and corporations for final selection by way of elimination, background verification, hiring and onboarding, thereby facilitating rendering HTMAAS in the context of the cloud computing system, in accordance with the principles of the present invention.

In some illustrative embodiments, for purposes of clarity and expediency, and to avoid reiterations in any and all references made, wherever and whenever required, to any and all terms or phrases with synonyms and, those that may be thus semantically repetitive, the term or phrase “candidates” may hereinafter interchangeably refer to, or comprise, at least one of “job applicants,” “job aspirants,” “job seekers,” “trainees,” “interns,” “apprentices,” “freshers” and “jobless”, and the like, in accordance with the principles of the present invention.

Likewise, in some illustrative embodiments, for purposes of clarity and expediency, and to avoid reiterations in any and all references made, wherever and whenever required, to any and all terms or phrases with synonyms and, thus semantically repetitive, the term or phrase “third-party subject matter experts” may hereinafter interchangeably refer to, or comprise, at least one of “interviewers,” “professional assessors” and “experienced amateur assessors”.

Still likewise, in some illustrative embodiments, for purposes of clarity and expediency, and to avoid reiterations in any and all references made, wherever and whenever required, to any and all terms or phrases with synonyms and, thus semantically repetitive, the term or phrase “employers” may hereinafter interchangeably refer to at least one of “potential employers,” “companies,” “job providers,” “hirers,” “organizations” and “corporations”.

In some detailed embodiments involving deployment of the Human Talent Management-As-A-Service (HTMAAS) in the context of cloud computing system hosted and managed by one or more host (or hosting) service(s) aggregators, the at least one method for rendering Human Talent Management-As-A-Service (HTMAAS) may comprise:

A) at least one of ethically, selectively securely, accurately, legitimately and legibly capturing at least one of textual, visual, audio, video data, and combinations thereof, for example multimedia data, corresponding to, and representing the at least one of biographical, biological, physiological, credential, identification data (or information), and combinations thereof, for example at least one of Personally Identifiable Information (PII), Sensitive Personal Information (SPI), non-PII, non-SPI data, and combinations thereof, for selectively using the same instantly as administrative data and subsequently as non-administrative data (or information) of, or for, one or more users, for purposes of at least one of i) registration and subscription of the one or more new users to the HTMAAS, ii) archival (or storage) and processing (or analyses) of the records of the newly registered subscribers or users, iii) at least one of Authentication, Authorization and Accounting (AAA) of the one or more new registered users or subscribers subsequently accessing and exploiting the HTMAAS as return users, and combinations thereof, iv) subsequent assessments of the foregoing users, subject to the prevailing context-of-use of the HTMAAS, wherein the foregoing users may comprise 1) the potential candidates, voluntarily accessing the HTMAAS for registering and subscribing thereto, 2) the potential 3PSMEs crowdsourced from the public domain by the host (or hosting) service(s) aggregators and voluntarily accessing the HTMAAS for registering and subscribing thereto, and 3) the potential employers, at least one of voluntarily accessing, registering and subscribing to the HTMAAS, via at least one of user requests, queries, inputs and responses to at least one of subjective, objective questionnaire, and a combination thereof;

B) securely archiving (or storing) the at least one of captured textual, visual, audio, video data, and combinations thereof, for instant and subsequent processing, i.e. analyzing both the administrative and non-administrative multimedia data (or information), of the one or more new users for subsequent use and reuse;

C) registering the one or more new users as subscribers to the HTMAAS;

D) issuing unique user login credentials to each of the one or more newly registered users or subscribers, i.e. a User Identifier (UID) and a Password (PWD), for accessing and exploiting the HTMAAS;

E) at least one of Authenticating, Authorizing, Accounting (AAA) the one or more newly registered users or subscribers accessing the HTMAAS as the return users, and combinations thereof;

F) at least one of optionally automatically and autonomously, analyzing the at least one of textual, visual, audio, video data, and combinations thereof, for example both the administrative and non-administrative multimedia data (or information) of the one or more AAA registered users or subscribers, using at least one of AI-, ML-based analysis, and a combination thereof;

G) at least one of optionally automatically and autonomously, profiling the one or more AAA registered users (or subscribers) using at least one of AI-, ML-based profiling, and a combination thereof, subject to the results of the analyses;

H) at least one of optionally automatically and autonomously, categorizing the one or more AAA registered users (or subscribers) using at least one of AI-, ML-based categorization, and a combination thereof, subject to the corresponding profiles;

I) at least one of automatically and autonomously, providing at least one of contextual, context-based, -aware, -sensitive and -dependent recommendations to the one or more AAA registered users (or subscribers) using at least one of AI-, ML-based recommendation, and a combination thereof, comprising:
i) at least one of automatically and autonomously, providing recommendations in connection with at least one of most optimal, relevant, average, worst and best jobs relevant to, and based on the corresponding profiles of the one or more AAA registered users posing as interviewee subscribers,
ii) at least one of automatically and autonomously, providing recommendations in connection with at least one of most optimal and best 3PSMEs for pre-assessment of the potential candidates based partly on the corresponding profiles of the potential 3PSMEs and partly on at least one of corresponding requirements, requests, expectations and demands of the one or more AAA registered users, for instance the potential candidates, in connection with the 3P mock interviews,
iii) at least one of automatically and autonomously, providing recommendations in connection with at least one of most optimal and best pre-assessed candidates relevant to, and based partly on the at least one of job positions, offers and jobs, and the corresponding job descriptions, requirements, specifications, at least one of requested, required, expected, demanded and desired profiles, qualifications, experience, logistics, roles, responsibilities and skillset thereof, as well as partly on the corresponding historical career paths, career movements, career graphs, employment records, backgrounds, job attitude, job control, job performance, job referrals and overall profiles of the pre-assessed candidates, and

J) at least one of optionally automatically and autonomously, tracking efficacy of any and all recommendations made using the at least one of AI-, ML-based recommendation, and combination thereof AI;

K) in operation, subjecting the potential candidates accessing and exploiting the cloud computing based human talent management system as Authenticated, Authorized, and Accounted (AAA) return users registered to the HTMAAS, and thus posing as the interviewee subscribers, to at least one of unbiased, genuine and mock Third-Party (3P) employment (or job) evaluations (or pre-assessments), for instance at least one of eligibility, trainability, employability, sustainability assessments, and combinations thereof, by one or more selectively engaged 3PSMEs accessing and exploiting the HTMAAS as AAA return users registered, and thus posing as interviewer subscribers, comprising:
i) at least one of locally and remotely hosting at least one of offline face-to-face (or one-on-one or one-to-one) and online employment (or job) interviews correspondingly, against one or more potential job positions, offers and jobs, the corresponding aspects, for example the corresponding job descriptions, requirements, specifications, as well as at least one of requested, required, expected, demanded and desired profiles, qualifications, experience, logistics, roles, responsibilities and skillset thereof comprising inter alia one-to-one (or one-on-one) communication between the interviewee (or candidate) subscribers and interviewer (or subject matter expert) subscribers, for instance at least one of explicitly user-selected and implicitly system-selected (or recommended) matching 3PSMEs;
ii) at least one of ethically, permissibly, selectively securely, accurately, legitimately and legibly recording, archiving and storing the contents of the at least one of offline face-to-face and online employment and job interviews, and one or more phases thereof, for example pre-interview, interview and post-interview phases, at least one of in excerpts, part and entirety, comprising at least one of textual, visual, video, audio data (or information), and combinations thereof, for example audio, visual, audio-video, audio-visual and multimedia data (or information), for instance selectively captured and archived interview transcriptions, for example textual and visual data (or information), for instance educational transcripts, responses to interview questions (or questionnaires), namely situational interview, behavioral interview, background, job knowledge, brain teaser (or metal ability) questions, whilst maintaining the at least one of pseudonymity and anonymity of the 3PSMEs; and
iii) allowing the potential candidates and at least one of anonymous and pseudonymous 3PSMEs in at least one of fully and partially manually, at least one of mutually reviewing, pre-assessing, assessing and rating each other;

L) re-subjecting the pre-assessed candidates for one or more genuine assessments by the potential employers for final selection by way of elimination, hiring and onboarding, thereby facilitating rendering HTMAAS in the context of the cloud computing system, in accordance with the principles of the present invention.

In some detailed embodiments involving deployment of the Human Talent Management-As-A-Service (HTMAAS) in the context of cloud computing based human talent management system hosted and managed by the potential employers, the potential employers may at least one of buy- and license-in the HTMAAS from the by one or more host (or hosting) service(s) aggregators to solely host and implement the HTMAAS.

In some preferred embodiments, for example, and in no way limiting the scope of the invention, the cloud computing based human talent management system, and one or more of the methods practiced thereby, for cooperatively facilitating rendering Human Talent Management-As-A-Service (HTMAAS) may comprise 1) at least one of partially manual, AI-, ML-based pre-assessment of the potential candidates, and combinations thereof, in turn, comprising at least one of i) pre-assessment of the potential candidates via implementation of at least one of AI- and ML-based chatbots and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, may render one or more cloud services or cloud computing services, including, but not limited to, the HTMAAS, under one or more cloud-based service models, in accordance with the principles of the present invention.

In some operating embodiments involving the implementation of the cloud computing based human talent management system, the system may facilitate ubiquitous, convenient, on-demand network access to a shared pool of configurable computing resources, such as networks, servers, storage, applications, and services, which resources may be rapidly provisioned and released with minimal management effort or service provider interaction. In some illustrative embodiments, the cloud computing based human talent management system may comprise one or more components, namely a cloud application, cloud client, cloud infrastructure, cloud platform, cloud service, cloud server, cloud database and cloud storage.

In some optional embodiments, the cloud computing based human talent management system may facilitate providing overall human talent management services via licensing and delivery of the method for rendering Human Talent Management-As-A-Service (HTMAAS) comprising 1) at least one of partially manual, AI-, ML-based pre-assessment of the potential candidates, and combinations thereof, in turn, comprising at least one of i) pre-assessment of the potential candidates via implementation of at least one of AI- and ML-based chatbots (or interview bots) and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, under the Software-As-A-Service (SAAS) cloud computing service model, which is a software licensing and delivery model, wherein one or more standalone applications render one or more corresponding business services, in accordance with the principles of the present invention.

In some optional embodiments, unlike SAAS, which provides business services, Service-Oriented Architecture (SOA) may facilitate providing small isolated processes as a service. In some operational embodiments, SOA may offer services to other applications, as opposed to SAAS that may offer services to users.

In some alternative embodiments, the cloud computing based human talent management system may facilitate providing overall human talent management services via licensing and delivery of the method for rendering Human Talent Management-As-A-Service (HTMAAS) comprising 1) at least one of partially manual, AI-, ML-based pre-assessment of the potential candidates, and combinations thereof, in turn, comprising at least one of i) pre-assessment of the potential candidates via implementation of at least one of AI- and ML-based chatbots (or interview bots) and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby cooperatively facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, over the Internet to at least one of employers, for instance corporate and academic or educational institutions, candidates or job seekers, recruitment service providers, and one or more host (or hosting) service(s) aggregators, as at least one of agnostic and non-agnostic services.

In some operating embodiments, agnostic services may be neither aware of the context in which the services may be called, nor aware of the modus operandi of implementation of the services, thereby rendering the services at least one of device-, protocol-, vendor-, platform-, hardware-, business process-, network-, technology-agnostic, and combinations thereof, in accordance with the principles of the present invention.

In some optional embodiments, the cloud computing based human talent management system may facilitate delivery of services under the Software-As-A-Service (SAAS) model, which is a software licensing and delivery model, wherein one or more standalone applications render one or more corresponding business services. In some optional embodiments, unlike SAAS, which provides business services, Service-Oriented Architecture (SOA) may facilitate providing small isolated processes as a service. In some operational embodiments, SOA may offer services to other applications, as opposed to SAAS that may offer services to users.

As used in general, the term “Service-Oriented Architecture or SOA” refers to an architectural pattern in computer software design, wherein application components provide services to other components via a communications protocol, typically over a network. The principles of service-orientation are independent of any vendor, product or technology, thereby rendering the SOA at least one of vendor-, product-, technology-agnostic and combinations thereof. SOA facilitates creating a program or application focused around distinct tasks or services, wherein each piece of the program or application performs a specific task, such as retrieving a piece of data, performing an operation, etc., and wherein the tasks are performed completely independent of each other.

In some preferred embodiments involving design and implementation of a SAAS application software for facilitating implementing the one or more of the methods for rendering at least one of device-, protocol-, network-, vendor-, platform-, hardware-, business process-, network-, technology-agnostic human talent management services, and combinations thereof, in the context of the cloud computing based human talent management system, SOA based design may be used, in accordance with the principles of the present invention. In some related embodiments, the SAAS application software may be designed and built on top of the SOA architecture, i.e. SOA-based SAAS application software, thereby facilitating easy scalability vis-à-vis a relatively more monolithic non-SOA-based SAAS application software. More specifically, SOA may facilitate practicing an architecture style in connection with building software, wherein an application is built or designed by assembling, or interacting with, a set of stateless, reusable, decoupled network services, e.g. web services.

In some embodiments, in the light of the need for securely controlled maximal reach (or scope of use) and deployment of the cloud computing based human talent management system, and the methods practiced thereby, design and implementation of a secure proprietary client-server SOA-based SAAS application software that may be at least one of platform independent, platform-agnostic, multi-platform and cross-platform compatible is disclosed, in accordance with the principles of the present invention. For example, and in no way limiting the scope of the invention, the secure proprietary client-server SOA-based SAAS application software may be custom developed (or built or compiled) to be deployed and implemented across multiple embedded OSs, mobile Operating Systems (or mobile OSs) supported, namely ANDROID™, IOS®, WINDOWS®, BB™, and the like. In some embodiments, by virtue of the intrinsic or inbuilt property of at least one of “platform independence,” “cross-platform compatibility” and “multi-platform compatibility”, the secure proprietary client-server SOA-based SAAS application software may directly run on any platform without special preparation or may inter-operate on multiple computer platforms, wherein the secure proprietary client-server SOA-based SAAS application software may be written in an interpreted language or pre-compiled compiled portable bytecode for which the interpreters or run-time packages may be common or standard components of all platforms.

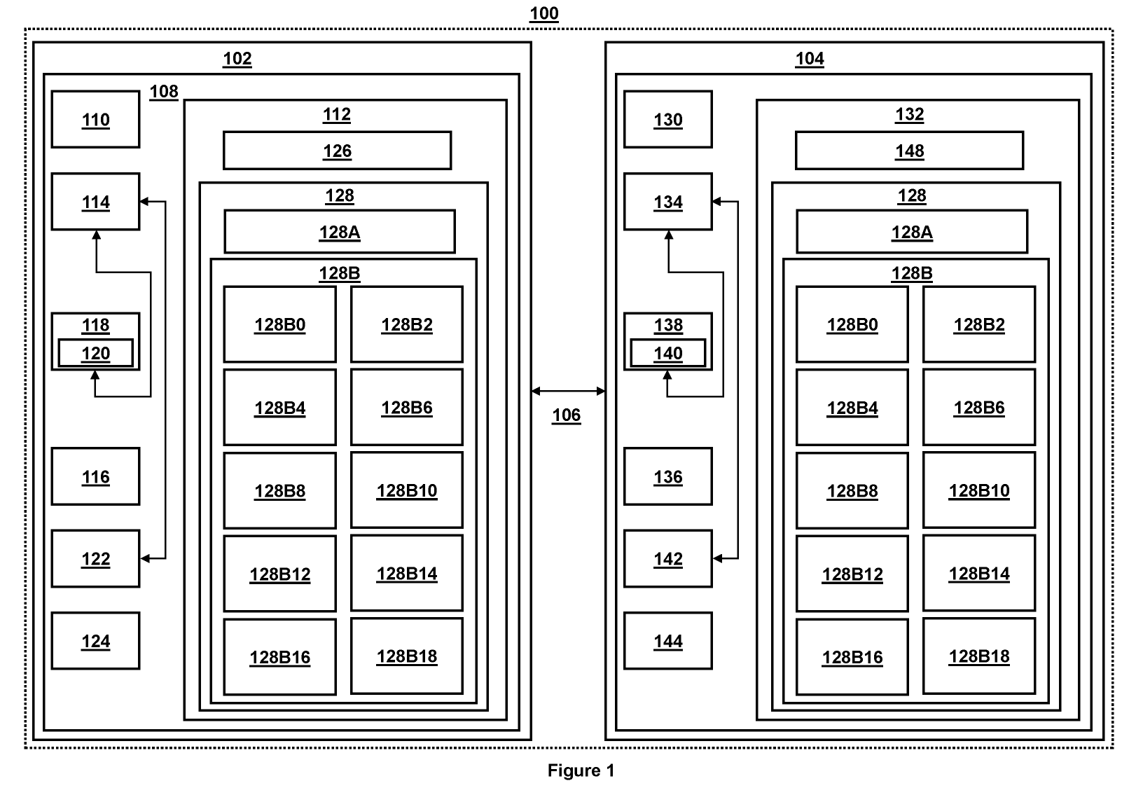

FIG. 1 depicts a block diagram of the cloud computing based human talent management system facilitating providing overall human talent management services via licensing and delivery of the method for rendering Human Talent Management-As-A-Service (HTMAAS) comprising 1) at least one of partially manual, AI-, ML-based pre-assessment of the potential candidates, and combinations thereof, in turn, comprising at least one of i) pre-assessment of the potential candidates via implementation of at least one of AI- and ML-based chatbots (or interview bots) and ii) pre-assessment by at least one of partially manually selected, AI- and ML-searched-cum-recommended at least one of most optimal and best Third-Party Subject Matter Experts (3PSMEs), and combinations thereof, as well as at least one of AI-, ML-based search-cum-recommendation of at least one of most optimal, relevant and best potential jobs, and combinations thereof, announced and published in the public domain by one or more potential employers, for the at least one of potential and pre-assessed candidates; 2) upon pre-assessment, at least one of partially manual, AI-, ML-based assessment of the selectively engaged 3PSMEs by the pre-assessed candidates, and combinations thereof; 3) at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers comprising i) at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, ii) at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, iii) at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers and 4) at least one of AI-, ML-based background investigation and verification of the interviewed candidates, thereby cooperatively facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, according to one or more embodiments.

In some simple embodiments, as depicted in FIG. 1, the system 100 may comprise at least one server subsystem 102, at least one client subsystem 104 and at least one network subsystem 106, in accordance with the principles of the present invention.

In some preferred embodiments, the system 100 may be in essence the cloud computing based human talent management system, designed and implemented in accordance with the principles of the present invention.

In some operational embodiments, both the at least one server and client subsystems 102 and 104 may be mutually at least one of operably, communicably and controllably coupled to the at least one network subsystem 106, in accordance with the principles of the present invention.

In some related embodiments, the client subsystem 104 may comprise one or more cloud (or cloud connected) clients, in accordance with the principles of the present invention.

In some practical embodiments, for example, and in no way limiting the scope of the invention, the at least one server subsystem 102 may comprise one or more cloud servers 102. In some limited embodiments, the at least one server subsystem 102 may comprise the at least one cloud server 102, in accordance with the principles of the present invention.

In some exemplary embodiments, for example, and in no way limiting the scope of the invention, the at least one cloud server 102 may comprise the at least one of cloud storage, cloud database (neither numbered, nor shown), and a combination thereof.

In some preferred embodiments, for example, and in no way limiting the scope of the invention, the at least one cloud server 102 may be a human talent management (or control) cloud server.

In some exemplary embodiments, the cloud server 102, for instance the human talent management (or control) cloud server, may be a logical server built, hosted and delivered through implementation of a cloud platform (neither shown, nor numbered), for instance at least one of GOOGLE® CLOUD PLATFORM, CITRIX® CLOUDPLATFORM, FUJITSU CLOUD SERVICE S5®, AMAZON WEB SERVICES® (AWS®), and the like, deployed in the context of the cloud computing based human talent management system 100 over the at least one network subsystem 106, for example the Internet, specifically, for instance Intercloud, an interconnected global “cloud of clouds” and an extension of the Internet “network of networks”, which Intercloud may be based thereupon. By virtue of functionality, the human talent management (or control) cloud server 102 may possess and exhibit similar capabilities and functionalities to any typical server, but may be accessed remotely by a cloud service provider (neither shown, nor numbered). In some alternative embodiments, the human talent management (or control) cloud server 102 may primarily be an Infrastructure-As-A-Service (IAAS) based cloud service model. For example, and in no way limiting the scope of the invention, the human talent management (or control) cloud server 102 may be at least one of logical and physical human talent management (or control) cloud server, wherein the logical human talent management (or control) cloud server 102 may be delivered through server virtualization facilitating partitioning the physical human talent management (or control) cloud server 102 into number of small, virtual servers, thereby resulting in maximizing the server resources, whereas under the server virtualization model, the physical human talent management (or control) cloud server 102 may be logically distributed into two or more logical human talent management (or control) cloud servers 102, each of which may have separate OS, UI and apps, although the two or more logical human talent management (or control) cloud servers 102 may share physical components from the underlying physical talent management (or control) cloud server 102, wherein the physical talent management (or control) cloud server 102 may also be accessed through the Internet remotely, however the physical talent management (or control) cloud server 102 may not be shared or distributed, and which may be commonly known as a dedicated cloud server. In some specific embodiments, the cloud storage may be an online network storage facilitating storing data or information therein, as well as accessing the stored data or information using multiple cloud clients 104. More specifically, for example, and in no way limiting the scope of the invention, the cloud storage may be deployed in the following configurations or deployment models, namely at least one of a public cloud, private cloud, community cloud and one or more combinations thereof, namely a hybrid cloud, and others, namely distributed cloud, Intercloud and Multicloud. In some advantageous embodiments, for example, and in no way limiting the scope of the invention, the cloud storage may facilitate agility, flexibility, scalability, multi-tenancy, and security from the storage perspective. In some illustrative embodiments, the cloud storage may be a model of data storage, wherein the digital data may be stored in logical pools, whereas the physical storage may span across multiple servers (and often locations), and the physical environment may be typically owned and managed by a hosting company.

In some exemplary embodiments, the at least one network subsystem 106 may comprise at least one wireless cloud communication network, wherein the at least one server and client subsystems 102 and 104 may be mutually coupled through the at least one network subsystem 106.

In some alternative embodiments involving deployment of the cloud computing based human talent management system 100, for example, and in no way limiting the scope of the invention, the at least one server subsystem 102 may comprise at least one cloud server, whereas the at least one client subsystem 104 may comprise one or more cloud clients 104, and wherein the at least one cloud server 102 and the one or more cloud clients 104 may be at least one of operably, communicably and controllably coupled to each other through the at least one wireless cloud communication networks 106, for instance a cloud network. In some exemplary embodiments, for example, and in no way limiting the scope of the invention, the cloud network 106 may comprise at least one of a Cloud-Enabled Network (CEN) and Cloud-Based Network (CBN), for instance a collaborative CBN based on a client-server model for cloud computing.

In some practical embodiments involving deployment and implementation of the CEN in the context of the cloud computing based human talent management system, the CEN 106 may facilitate moving management and certain aspects of control, such as policy definition, into the cloud, however retaining connectivity and packet-mode functions, such as routing, switching and security services, locally and often in hardware. On the contrary, in some selected embodiments involving deployment and implementation of the CBN, the CBN 106 may facilitate moving all core networking functions, including addressing and the actual packet path, into the cloud and eliminating the need for any local hardware other than that which provides an Internet connection. Specifically, the CBN 106 may be referred to as Network-As-A-Service (NAAS), since NAAS follows the same subscription and delivery model as Software-As-A-Service (SAAS) solutions. In some related embodiments involving delivery of NAAS via CBN, the NAAS may be rendered as a cloud-based service, wherein users may be allowed to purchase computing infrastructure on a compute/hour basis. By contrast, in some optional embodiments, users may contract with a hosting provider to manage hosted servers. AIthough, both CBN and CEN may facilitate delivering computing as a service, but the economics, extensibility, and capabilities between the two approaches may vary widely. In the same vein, in some selected embodiments involving deployment and implementation of cloud-based NAAS, the cloud-based NAAS may be built as an overlay on global cloud data centers and utilize Software-Defined Networking (SDN) and virtualization technologies to provide an elastic and resilient NAAS, thereby facilitating hosting multiple virtual network services. In some scenarios, one or more NAAS providers may simply host single-function network equipment or virtual appliances in co-location centers and sell access and management as service.

In some practical embodiments, the CBN 106 may only require an Internet connection and may work over any physical infrastructure, wired or wireless, public or private. In some related embodiments, the CBN 106 may have the added benefit of not requiring any additional hardware beyond that required for Internet connectivity. In some specific embodiments, by virtue of design and implementation, the cloud network 106 may be similar to a Virtual Private Network (VPN), thereby enabling users to securely access files, printers, applications, etc. from anywhere in the world, anytime and on any device. In some exemplary embodiments, for example, and in no way limiting the scope of the invention, the cloud network 106 may be multi-tenant private virtual cloud network that overlays the Internet. In some operating embodiments, the VPN 106 may function like a borderless LAN and may provide fully switched, any-to-any connectivity between servers, PCs, and mobile devices from anywhere. In some practical embodiments, the cloud database (neither numbered, nor shown) may be a database that typically may be hosted, and thus runs, on the cloud server 102, for instance the human talent management (or control) cloud server 102, whereby access thereto may be provided as a service.

In some practical embodiments, the cloud server 102 may comprise one or more host computing units 108. In some detailed embodiments, each of the host computing units 108 may comprise a first microprocessor subunit 110, first memory subunit 112, first Input/Output (I/O) subunit 114 and first set of support circuits 116, respectively. In some related embodiments, each of the host computing units 108 may comprise a first communication subunit 118 coupled to the first I/O subunit 114. The first communication subunit 118 may comprise a first wireless transceiver 120.

For example, and in no way limiting the scope of the invention, in some practical embodiments, the first wireless transceiver 120 may comprise at least one of a General Packet Radio Service (GPRS) transceiver, Global System for Mobile Communications (GSM) transceiver, Near Field Communication (NFC) transceiver, BLUETOOTH® transceiver, 3G/4G cellular transceiver, Wi-Fi transceiver, and the like. In some related embodiments, each of the host computing units 108 may comprise a first display subunit 122. In some operating embodiments, both the first communication subunit 118 and first display subunit 122 may be coupled to the first I/O subunit 114. In some related embodiments, each of the host computing units 108 may comprise a first positioning subunit 124. For example, and in no way limiting the scope of the invention, the first positioning subunit 124 may be based on Global Positioning System (GPS).

In some practical embodiments, the first memory subunit 112 may comprise a first Operating System (OS) 126. Specifically, the first OS 126 may be at least one of a platform agnostic and independent OS. In addition, the first memory subunit 112 may comprise the server-side of a secure proprietary client-server SOA-based Human Talent Management-As-A-Service (SOAHTMAAS) modular application software 128. In some practical embodiments, the server-side of the secure proprietary client-server SOAHTMAAS modular application software 128 may comprise a SOA-based Integrated Background Investigation and Verification-As-A-Service (SOAIBIVAAS) application software component 128A and SOA-based Artificial Intelligence/Machine Learning-As-A-Service (SOAAIMLAAS) application software component 128B, in accordance with the principles of the present invention.

In some detailed embodiments, the SOA-based Artificial Intelligence/Machine Learning-As-A-Service (SOAAIMLAAS) application software component 128B may comprise a SOA-based Virtual Assistant-As-A-Service (SOAVAAAS) application software sub-component 128B0, SOA-based Career Pattern Recognizer-As-A-Service application software sub-component 128B2, SOA-based Lexical Analyzer (or Analysis)-As-A-Service (SOALAAAS) application software sub-component 128B4, SOA-based Syntax Analyzer (or Analysis)-As-A-Service (SOAS4XAAAS) application software sub-component 128B6 and SOA-based Semantic Analyzer (or Analysis)-As-A-Service (SOAS6CAAAS) application software sub-component 128B8, SOA-based Chatbot-As-A-Service (SOACAAS) application software sub-component 128B10, SOA-based Facial Detection, Recognition and Perception-As-A-Service (SOAFDRPAAS) application software sub-component 128B12, SOA-Based Optimal Candidate Search/Recommender-As-A-Service (SOAOCSRAAS) application software sub-component 128B14, SOA-Based Optimal Evaluator Search/Recommender-As-Service (SOAOESRAAS) sub-component 128B16 and SOA-Based Optimal Job Search/Recommender-As-Service (SOAOJSRAAS) sub-component 128B18, in accordance with the principles of the present invention.

In some practical embodiments, the first Operating System (OS) 126 may be at least one of a cloud-based, cloud-enabled and cloud OS. In some specific embodiments, the first OS 126 may be a platform agnostic cloud OS. Specifically, the cloud OS 126 may be designed to operate within cloud computing and virtualization environments. More specifically, the cloud OS or cloud-based OS 126 may be a set of applications and programs running on each of the host computing units 108. Except that, the whole service relies on Internet, and the applications available within each of the host computing units 108, as well as each of the host computing units 108 in entirety, may not be installed on the cloud clients 104.

In some alternative embodiments, the first OS 126 may be Internet OS, which refers to any type of OS designed to run all the applications and services thereof, or therefor, through an Internet server, generally a web server browser. Advantageously, the Internet OS 126 may run on a thin client, for instance cloud clients 104, thereby facilitating cheaper and more easily manageable computer systems. In some embodiments involving deployment and implementation of the Internet OS, all applications may be designed based on open standards to be cross-platform compatible, thereby facilitating eliminating dependency of client-specific applications, and preferences thereof, upon a single computer via uploading and storing the client-specific applications, and preferences thereof, on the cloud. As a consequence, the Internet OS 126 may serve as the perfect type of platform for SAAS. In some practical embodiments, the first OS 126 may be cloud OS. In some specific embodiments, the first OS 126 may be a platform agnostic cloud server OS.

In some practical embodiments, specifically the secure proprietary client-server SOAHTMAAS modular application software 128 may be at least one of a desktop web application software, mobile web application software and embedded web application software. More specifically, in some practical embodiments, for example, and in no way limiting the scope of the invention, the secure proprietary client-server SOAHTMAAS modular application software 128 may be a client-server application software respectively, which a client (or User Interface or UI or Web UI (WUI) or Web-based UI thereof), for instance the cloud clients 104 comprising the client-side of the secure proprietary client-server SOAHTMAAS modular application software 128, or the UI therefor, may run in a web browser including at least one of a mobile web browser, desktop web browser and an embedded web browser (not numbered and shown schematically), installed on the cloud clients 104.

More specifically, in some practical embodiments, for example, and in no way limiting the scope of the invention, the secure proprietary client-server SOAHTMAAS modular application software 128 may be at least one of a distributed client-server application software comprising both client and server software, for instance both the client- and server-sides and of the secure proprietary client-server SOAHTMAAS modular application software 128, wherein the client-side of the secure proprietary client-server SOAHTMAAS modular application software 128 may be a client-agnostic web application software, for instance at least one of a client-agnostic desktop web application software, client-agnostic mobile web application software and client-agnostic embedded web application software.

In some potential embodiments, for example, and in no way limiting the scope of the invention, the secure proprietary client-server SOAHTMAAS modular application software may be at least one of a mobile web, desktop web, embedded web and hybrid application software. In some exemplary embodiments involving addressing inabilities of the at least one of desktop and mobile web application software to access one or more sensors of 1) the at least one of embedded and general-purpose, at least one of smart and retrofit smart, at least one of fixed, portable and wearable computing and communications devices 104 and 2) the at least one of embedded and general-purpose, at least one of smart and augmented smart connected appliances (or equipment or apparatuses or devices or products) 104, whilst maintaining the cross-platform support thereof, the hybrid application software may facilitate accessing the one or more sensors of 1) the at least one of embedded and general-purpose, at least one of smart and retrofit smart, at least one of fixed, portable and wearable computing and communications devices, for instance the cloud clients 104 and 2) at least one of embedded and general-purpose, at least one of smart and augmented smart connected appliances (or equipment or apparatuses or devices or products) 104, via running inside at least one of a desktop and mobile web browser. However, from the standpoint of design and implementation, unlike the at least one of desktop and mobile web application software, the at least one of desktop and mobile web browser may be embedded inside a container application software native to 1) the at least one of embedded and general-purpose, at least one of smart and retrofit smart, at least one of fixed, portable and wearable computing and communications devices, for instance the cloud clients 104 and 2) the at least one of embedded and general-purpose, at least one of smart and augmented smart connected appliances (or equipment or apparatuses or devices or products) 104, thereby providing a bridge between the hybrid application software and low-level functions of 1) the at least one of embedded and general-purpose, at least one of smart and retrofit smart, at least one of fixed, portable and wearable computing and communications devices, and 2) at least one of embedded and general-purpose, at least one of smart and augmented smart connected appliances (or equipment or apparatuses or devices or products). Yet, in some practical embodiments, for example, and in no way limiting the scope of the invention, the secure proprietary client-server SOAHTMAAS modular application software 128 may be a cloud application software. Specifically, the secure proprietary client-server SOAHTMAAS modular cloud application software 128 may often facilitate eliminating the need to install and run the cloud application software on the end user client device, for instance the cloud clients 104, thus reducing software maintenance, ongoing operations, and support. In some practical embodiments, for example, and in no way limiting the scope of the invention, the cloud clients 104 may be at least one of a fat, thin and hybrid client subject to the hardware and software requirements of the secure proprietary client-server SOAHTMAAS modular web application software 128 in connection with one or more possible scenarios.

In some alternative embodiments, for example, and in no way limiting the scope of the invention, each of the thin clients 104 may be a web thin client. In use, the web thin clients 104 may only provide a web browser (not numbered and shown schematically), and rely on one or more web application software, including, but not limited to, for instance the secure proprietary client-server SOAHTMAAS modular web application software 128, to provide at least one of application-specific and general-purpose computing functionality. However, in use, the secure proprietary client-server SOAHTMAAS modular web application software 128 may use web storage to store some data locally, e.g. for “offline mode”, and perform significant processing tasks as well. In some scenarios involving deployment and implementation of Rich Internet Applications (RIAs) on web thin clients, for instance at least a plurality of the web thin clients 104, the RIAs may cross the boundary, for instance HTML5 web applications leverage browsers as run-time environments through the use of a cache manifest or so called “packaged apps”, for instance in case of FIREFOX® OS and CHROME®. Further, examples of web thin clients include CHROMEBOOK®(s) and CHROMEBOXE®(s), which run CHROME® OS, and phones running FIREFOX® OS. Still further, CHROMEBOOK®(s) and CHROMEBOXE®(s) also have the capability of remote desktop using the free CHROME® Remote Desktop browser extension, which means, other than a web thin client, the CHROMEBOOK®(s) and CHROMEBOXE®(s) are also used as an ultra-thin client to access PC or Mac applications that do not run on the CHROMEBOOK® directly. In use, the CHROMEBOOK®(s) and CHROMEBOXE®(s) are used as a web thin client and an ultra-thin-client simultaneously, with the user switching between web browser and PC or Mac application windows with a click. CHROMEBOOK®(s) are also capable of storing user documents locally, with the exception of media files, which have a dedicated player application to play, all such files are only opened and processed with web applications, since traditional desktop applications cannot be installed in CHROME OS.

In some alternative embodiments, the cloud clients 104 may comprise at least one of computer hardware, software, and a combination thereof, that relies on cloud computing for application software delivery, or that is specifically designed for delivery of cloud services and that, in either case, may be essentially useless without cloud computing. Examples include some computers, phones and other devices, operating systems and browsers. In use, users may access cloud computing using networked client devices, such as desktop computers, laptops, tablets and smartphones and any Ethernet enabled device, such as home automation gadgets. In some scenarios, one or more of the aforementioned devices, for instance at least a plurality of the cloud clients 104 relies on cloud computing for all or a majority of the applications thereof so as to be essentially useless without cloud computing. Examples are thin clients and the browser-based CHROMEBOOK®. In some other scenarios, many cloud applications may not require specific software on the client and instead use a web browser to interact with the cloud application. With AJAX and HTML5 the web User Interfaces (Uls) achieves a similar, or even better, look and feel to native applications. Some cloud applications, however, support specific client software dedicated to these applications (e.g., virtual desktop clients and most email clients). Some legacy applications (line of business applications that until now have been prevalent in thin client computing) are delivered via a screen-sharing technology.

In some operational embodiments, in operation, the secure proprietary client-server SOAHTMAAS modular web application software 128 may provide a better way to share the workload. The client-side of the secure proprietary client-server SOAHTMAAS modular web application software 128 installed and running on any client, for instance the client subsystem 104 comprising inter alia a plurality of the at least one of embedded and general-purpose, at least one of smart and retrofit smart, at least one of fixed, portable and wearable computing and communications devices, for instance the cloud clients 104, and the at least one of embedded and general-purpose, at least one of smart and augmented smart connected appliances (or equipment or apparatuses or devices or products) 104, may always initiate a connection to the server, for instance the sever subsystem 102 comprising at least one host computing unit 108, while the server-side of the secure proprietary client-server SOAHTMAAS modular web application software 128 may always wait for requests from any client. In some limited embodiments, the client subsystem 104 may comprise one or more cloud clients 104. Each of the at least one of cloud clients 104 may comprise one or more of at least one of smart and retrofit smart, at least one of embedded and general-purpose, at least one of fixed, portable and wearable computing and communications devices, with at least one of inbuilt, embedded Global Positioning System (GPS) capability and add-on GPS capability by virtue of a retrofit (coupled) thereto, respectively.

In some embodiments, each of the one or more cloud clients 104 may comprise one or more of at least one of smart and retrofit smart, at least one of embedded and general-purpose, at least one of portable computing devices, portable communications devices, and a combination thereof, for instance at least one of smart and retrofit smart, at least one of embedded and general-purpose portable computing and communications devices with at least one of inbuilt Global Positioning System (GPS) capability and add-on GPS capability by virtue of a retrofit thereto, respectively. In some embodiments, the at least one of smart and retrofit smart, at least one of embedded and general-purpose portable computing devices may be at least one of a smart portable computer, smart tablet computer, smart Personal Digital Assistant (PDA), a smart ultra-mobile PC, a smart phone, smart carputer, smart pen top computer, smart speaker, and the like. Likewise, in some embodiments, the at least one of smart and retrofit smart, at least one of embedded and general-purpose portable communications devices may be at least one of a smart mobile device, and the like.

In some embodiments, the client subsystem 104 may comprise one or more of at least one of smart and retrofit smart, at least one of embedded and general-purpose, at least one of wearable computing devices, wearable communications devices, and a combination thereof, for instance at least one of smart and retrofit smart, at least one of embedded and general-purpose wearable computing and communications devices. For example, and in no way limiting the scope of the invention, the at least one of smart and retrofit smart, at least one of embedded and general-purpose smart wearable computing and communications devices may be at least one of a smart watch, smart band, smart glass, smart speaker, smart camera, smart sensors, smart microphone, and the like. In some embodiments, the client subsystem may comprise one or more of at least one of smart and retrofit smart, at least one of embedded and general-purpose, at least one of fixed computing devices, fixed communications devices, and a combination thereof, for instance at least one of smart and retrofit smart, at least one of embedded and general-purpose fixed computing and communications devices. For example, and in no way limiting the scope of the invention, the at least one of smart and retrofit smart, at least one of embedded and general-purpose fixed computing and communications device may be at least one of a smart PC, smart device, smart TV, smart display. In some practical embodiments, the client subsystem 104 may comprise one or more of at least one of partially manually-operated smart and retrofit smart, at least one of embedded and general-purpose, at least one of fixed, portable and wearable computing and communications devices.

Stated differently, or otherwise, for example, and in no way limiting the scope of the invention, the client subsystem 104 may comprise at least one of partially manually-operated smart and retrofit smart, at least one of embedded and general-purpose, at least one of fixed, portable and wearable computing and communications devices 104 owned and partially manually-operated by one or more users. In some alternative embodiments, the client subsystem 104 may comprise one or more of at least one of fully autonomous, fully automatic, and a combination thereof, at least one of partially manually-operated smart and retrofit smart, at least one of embedded and general-purpose, at least one of fixed and portable devices, appliances, apparatuses, connected products, and the like, for instance the cloud clients 104.

With reference to FIG. 1, in some preferred embodiments, each of the 1) at least one of partially manually-operated smart connected and retrofit smart connected, at least one of embedded and general-purpose, at least one of fixed, portable and wearable computing and communications devices, apparatuses, appliances, products as well as equipment serving or posing as the cloud clients 104 and 2) the at least one of fully and partially, at least one of autonomous and automatic, and combinations thereof, at least one of smart connected and retrofit smart connected, at least one of embedded and general-purpose appliances, devices, apparatuses, equipment and products serving or posing as the cloud clients 104 may comprise a second microprocessor unit 130, for instance at least one of an embedded microprocessor and microcontroller in the case of embedded cloud clients 104, a second memory unit 132, for instance at least one of an Embedded DRAM (eDRAM), Embedded SRAM (eSRAM), Embedded EPROM (eEPROM), Embedded EEPROM (eEEPROM), Embedded Flash Memory, Embedded ROM (eROM) in the case of the embedded cloud clients 104, a second Input/Output (I/O) unit 134, for instance an embedded I/O unit in the case of the embedded cloud clients 104, and second set of embedded support circuits 136, respectively. In addition, each of the cloud clients 104 may comprise a second communication unit 138, for instance an embedded communication unit in the case of the embedded cloud clients 104, coupled to the second I/O subunit 134. The second communication unit 138 may comprise a second wireless transceiver 140, for instance an embedded wireless transceiver in the case of the embedded cloud clients 104.

In some exemplary embodiments, for example, and in no way limiting the scope of the invention, the second embedded wireless transceiver 140 may comprise at least one of an embedded GPRS transceiver, embedded GSM transceiver, embedded NFC transceiver, BLUETOOTH® transceiver, embedded 3G/4G cellular transceiver, embedded Wi-Fi transceiver, and combinations thereof. In addition, each of the cloud clients 104 may comprise a second display unit 142. In some embodiments, both the second communication unit 138 and second display unit 142 may be coupled to the second Input/Output (I/O) unit 134. In addition, each of the cloud clients 104 may comprise a second positioning unit 144. For example, and in no way limiting the scope of the invention, the second positioning unit 144 may be based on Global Positioning System (GPS). In some related embodiments, each of the cloud clients 104 may comprise a second embedded GPS unit 146 (not shown here explicitly).

In some practical embodiments, the second memory subunit 132 may comprise a second Operating System (OS) 148. Specifically, the second OS 148 may be at least one of a platform agnostic and independent OS. In addition, the second memory subunit 132 may comprise the client-side of the secure proprietary client-server SOA-based Human Talent Management-As-A-Service (SOAHTMAAS) modular application software 128. In some practical embodiments, the client-side of the secure proprietary client-server SOAHTMAAS modular application software 128 may comprise the SOA-based Integrated Background Investigation and Verification-As-A-Service (SOAIBIVAAS) application software component 128A and SOA-based Artificial Intelligence/Machine Learning-As-A-Service (SOAAIMLAAS) application software component 128B, in accordance with the principles of the present invention.

In some detailed embodiments, the SOA-based Artificial Intelligence/Machine Learning-As-A-Service (SOAAIMLAAS) application software component 128B may comprise the SOA-based Virtual Assistant-As-A-Service (SOAVAAAS) application software sub-component 128B0, SOA-based Career Pattern Recognizer-As-A-Service application software sub-component 128B2, SOA-based Lexical Analyzer (or Analysis)-As-A-Service (SOALAAAS) application software sub-component 128B4, SOA-based Syntax Analyzer (or Analysis)-As-A-Service (SOAS4XAAAS) application software sub-component 128B6 and SOA-based Semantic Analyzer (or Analysis)-As-A-Service (SOAS6CAAAS) application software sub-component 128B8, SOA-based Chatbot-As-A-Service (SOACAAS) application software sub-component 128B10, SOA-based Facial Detection, Recognition and Perception-As-A-Service (SOAFDRPAAS) application software sub-component 128B12, SOA-Based Optimal Candidate Search/Recommender-As-A-Service (SOAOCSRAAS) application software sub-component 128B14, SOA-Based Optimal Evaluator Search/Recommender-As-Service (SOAOESRAAS) sub-component 128B16 and SOA-Based Optimal Job Search/Recommender-As-Service (SOAOJSRAAS) sub-component 128B18, in accordance with the principles of the present invention.

In some practical embodiments, the second Operating System (OS) 148 may be at least one of a cloud-based, cloud-enabled and cloud OS. In some specific embodiments, the second OS 148 may be a platform agnostic cloud OS. Specifically, the cloud OS 148 may be designed to operate within cloud computing and virtualization environments. More specifically, the cloud OS or cloud-based OS 148 may be a set of applications and programs running on each of the embedded cloud clients 104. Except that, the whole service relies on Internet, and the applications available within each of the embedded cloud clients 104, as well as each of the embedded cloud clients 104 in entirety, may not be installed on the cloud clients 104.

In some alternative embodiments, the second OS 148 may be Internet OS, which refers to any type of OS designed to run all the applications and services thereof, or therefor, through an Internet client, generally a web browser. Advantageously, the Internet OS 148 may run on a thin client, for instance the cloud clients 104, thereby facilitating cheaper and more easily manageable computer systems. In some embodiments involving deployment and implementation of the Internet OS, all applications may be designed based on open standards to be cross-platform compatible, thereby facilitating eliminating dependency of client-specific applications, and preferences thereof, upon a single computer via uploading and storing the client-specific applications, and preferences thereof, on the cloud. As a consequence, the Internet OS 148 may serve as the perfect type of platform for SAAS. In some practical embodiments, the second OS 148 may be cloud OS. In some specific embodiments, the second OS 148 may be a platform agnostic cloud client OS.

In some practical embodiments, the second Operating System (OS) 148 may be at least one of a cloud-based, cloud-enabled and cloud OS. In some specific embodiments, the second OS 148 may be a platform agnostic cloud OS. Specifically, the cloud OS 148 may be designed to operate within cloud computing and virtualization environments. More specifically, the cloud OS or cloud-based OS 148 may be a set of applications and programs running on each of the embedded cloud clients 104. Except that, the whole service relies on Internet, and the applications available within each of the embedded cloud clients 104, as well as each of the embedded cloud clients 104 in entirety, may not be installed on the cloud clients 104.

In some alternative embodiments, the second OS 148 may be Internet OS, which refers to any type of OS designed to run all the applications and services thereof, or therefor, through an Internet client, generally a web browser. Advantageously, the Internet OS 148 may run on a thin client, for instance the cloud clients 104, thereby facilitating cheaper and more easily manageable computer systems. In some embodiments involving deployment and implementation of the Internet OS, all applications may be designed based on open standards to be cross-platform compatible, thereby facilitating eliminating dependency of client-specific applications, and preferences thereof, upon a single computer via uploading and storing the client-specific applications, and preferences thereof, on the cloud. As a consequence, the Internet OS 148 may serve as the perfect type of platform for SAAS. In some practical embodiments, the second OS 148 may be cloud OS. In some specific embodiments, the second OS 148 may be a platform agnostic cloud client OS.

In some embodiments, the second OS 148 may be mobile Internet OS, which refers to any type of OS designed to run all the applications and services thereof, or therefor, through an Internet client, generally a web browser. Advantageously, the mobile Internet OS 148 may run on a thin client, thereby facilitating cheaper and more easily manageable computer systems. In some embodiments involving deployment and implementation of the mobile Internet OS, all applications may be designed based on open standards to be cross-platform compatible, thereby facilitating eliminating dependency of client-specific applications, and preferences thereof, upon a single computer via uploading and storing the client-specific applications, and preferences thereof, on the cloud. As a consequence, the mobile Internet OS 148 may serve as the perfect type of platform for SAAS. In some specific embodiments, the second OS 148 may be a platform agnostic cloud client OS.

In some alternative embodiments involving deployment of at least one of embedded devices, appliances, apparatuses, equipment and products, the at least one of embedded devices, appliances, apparatuses, equipment and products serving as embedded cloud clients 104 at least one of partially and fully autonomously operable, the second OS 148 may be an embedded OS and embedded cloud OS. Embedded OS may be designed to be compact, efficient at resource usage, and reliable, forsaking many functions that non-embedded computer Operating Systems (OSs) provide, and which may not be used by the specialized applications run thereupon. Embedded OS may be frequently also referred to as Real-Time Operating Systems, and the term RTOS may be often used as a synonym for embedded OS. Usually, the hardware running the embedded OS may be limited in resources, for instance the at least one of an Embedded DRAM (eDRAM), embedded ROM, a flash memory RAM and ROM, therefore systems made for embedded hardware tend to be specific, which means that due to the available resources (low if compared to non-embedded systems) the embedded systems may be created to cover specific tasks or scopes.

In some applicable embodiments involving implementation of the SOA-Based Optimal Candidate Search/Recommender-As-A-Service (SOAOCSRAAS) application software component in the context of the cloud computing based human talent management system, the SOAOCSRAAS application software component may facilitate at least one of fully and partially, at least one of autonomously and automatically, and combinations thereof, assessing Person-Environment Fit (P-E Fit) comprising at least one of Person-Organization Fit (P-O Fit), Person-Job Fit (P-J Fit), Person-Group Fit (P-G Fit) and Person-Person Fit (P-P Fit) in connection with the pre-assessed candidates, upon subjecting the pre-assessed candidates, accessing and exploiting the cloud computing based human talent management system as Authenticated, Authorized, and Accounted (AAA) return users registered to the secure proprietary client-server SOA-based Human Talent Management-As-A-Service (SOAHTMAAS) modular application software, and thus posing as the interviewee subscribers, to unbiased, genuine employment (or job) interviews conducted by the potential employers and hosted by the one or more host (or hosting) service(s) aggregators, in accordance with the principles of the present invention.

In some exemplary embodiments, for example, and in no way limiting the scope of the invention, the SOAOCSRAAS application software component may facilitate at least one of partially manual, AI-, ML-based search-cum-recommendation of at least one of most optimal and best pre-assessed candidates for the at least one of most optimal, average, worst, most relevant and best potential jobs announced and published in the public domain by the one or more potential employers, in accordance with the principles of the present invention.

In some relevant embodiments involving implementation of Person-Job Fit (P-J Fit) by the SOAOCSRAAS application software component, the P-J Fit may facilitate determining the compatibility of the characteristics of the pre-assessed (or potential) candidates, accessing and exploiting the cloud computing based human talent management system as Authenticated, Authorized, and Accounted (AAA) return users registered to the secure proprietary client-server SOA-based Human Talent Management-As-A-Service (SOAHTMAAS) modular application software, and thus posing as the interviewee subscribers, vis-à-vis the characteristics of corresponding specific potential jobs, against which the pre-assessed (or potential) candidates may at least one of have been selected and applied for, partly subject to at least one of the candidacy and candidature of the pre-assessed (or potential) candidates, and partly dependent on the at least one of assessments, reviews, ratings, feedbacks, comments, opinions, conclusions made subsequent to the at least one of unbiased, genuine and mock employment (or job) interviews conducted by at least one of second- and third-parties, in accordance with the principles of the present invention. In some operational embodiments, the foregoing complementary perspective may serve as the foundation for Person-Job Fit (P-J Fit). In some related embodiments, the Person-Job Fit (P-J Fit) may comprise the traditional view of selection that emphasizes the matching of employee Knowledge, Skills, and Abilities (KSAs) and other qualities to job demands, in accordance with the principles of the present invention. In some further related embodiments, the Person-Job Fit (P-J Fit) may comprise the discrepancy models of job satisfaction and stress that focus on the needs and desires of the potential candidates met by the supplies provided by the corresponding potential jobs, in accordance with the principles of the present invention.

In some relevant embodiments involving implementation of Person-Group Fit (P-G Fit) by the SOAOCSRAAS application software component, the P-G Fit may facilitate determining the compatibility of the characteristics of the potential candidates vis-à-vis the characteristics of corresponding potential groups to which the potential candidates may at least one of belong and assigned to, in accordance with the principles of the present invention. In some related embodiments, the P-G Fit may facilitate determining as to how the psychological compatibility between coworkers (or colleagues) influences individual outcomes in group situations, in accordance with the principles of the present invention. In some further related embodiments, the P-G Fit may be relatively more strongly related to group-oriented outcomes, for example co-worker satisfaction and feelings of cohesion.

In some relevant embodiments involving implementation of Person-Person Fit (P-P Fit) by the SOAOCSRAAS application software component, the P-P Fit may facilitate determining the compatibility of the cultural preferences of the potential candidate vis-à-vis the cultural preferences of the corresponding potential colleagues (or coworkers), in accordance with the principles of the present invention. In some related embodiments, the P-P Fit may correspond to the similarity-attraction hypothesis, whereby people are reciprocally drawn or attracted towards similar people based on at least one of respective values, attitudes and opinions, in accordance with the principles of the present invention. In some further related embodiments, the P-P Fit may take into consideration at least one of mentors, proteges, supervisors, peers, subordinates, applicants and recruiters, in accordance with the principles of the present invention. Yet, in some further related embodiments, the P-P Fit may facilitate determining Person-Supervisor Fit (P-S Fit), which is most strongly related to supervisor-oriented outcomes like supervisor satisfaction, in accordance with the principles of the present invention.

In some applicable embodiments involving implementation of the SOA-Based Optimal Candidate Search/Recommender-As-A-Service (SOAOCSRAAS) application software component in the context of the cloud computing based human talent management system, the SOAOCSRAAS application software component may facilitate implementation of the personality-job fit theory, wherein the personality-job fit theory hypothesizes that the personality traits of a potential candidate may reveal, or for that matter may facilitate gazing in and gaining, insight as to adaptability of the potential candidate within a given organization, in accordance with the principles of the present invention. In some applicable embodiments, the degree of confluence between a potential candidate and a given organization may be expressed as the Person-Organization (P-O) fit of the potential candidate, which may also be referred to as the Person-Environment Fit (P-E fit), in accordance with the principles of the present invention. In some operating embodiments, a common measure of the P-O Fit may be workplace efficacy, which is the rate at which workers are able to complete tasks. In some exemplary embodiments, the tasks may be mitigated by workplace environs, for example, a worker who may work, or works, more efficiently as an individual than in a team may have a higher P-O Fit for a workplace that stresses or emphasizes on individual tasks, which are managed single-handedly, for instance accountancy. In some potential embodiments, matching the right personality with the right job may facilitate company workers in achieving a better synergy and avoid pitfalls, for example high turnover and low job satisfaction, thereby resulting in minimizing the attrition rate of employees, whereas maximizing the probability of commitment of the employees towards the organizations with at least one of best and good personality-job fit, in accordance with the principles of the present invention.

In some practical embodiments involving implementation of Person-Organization Fit (P-O Fit) by the SOAOCSRAAS application software component, the P-O Fit may facilitate gauging integration with organizational competencies, wherein at least one of a potential candidate and employee may be assessed based on the organizational competencies, which may reveal efficacy, motivation, influence, and co-worker respect, in accordance with the principles of the present invention. In some exemplary embodiments, for example and in no way limiting the scope of the invention, competencies may be assessed using various tools, for instance psychological tests, assessment centers, competency based interviews, situational analysis, etc., in accordance with the principles of the present invention. In some scenarios involving display of high P-O Fit by at least one of potential candidates and employees, the probability of adjustment of the at least one of potential candidates and employees to the environment of a given company, and the work culture thereto may be high, thereby facilitating ensuring performance at an optimum level by the at least one of potential candidates and employees, in accordance with the principles of the present invention.

In some practical embodiments involving implementation of Person-Environment Fit (P-E Fit) by the SOAOCSRAAS application software component, the P-O Fit may facilitate determining the degree to which the characteristics of at least one of potential candidates and employees match vis-à-vis the characteristics of a given environment, for instance a corporate environment, in accordance with the principles of the present invention. In some exemplary embodiments, the characteristics of the at least one of potential candidates and employees may comprise the at least one of biological and psychological needs, values, goals, abilities, or personalities, whereas the environmental characteristics may comprise intrinsic and extrinsic rewards, demands of at least one of jobs and roles, cultural values, characteristics of other individuals and collectives in the social environment of the at least one of potential candidates and employees, in accordance with the principles of the present invention. In some relevant embodiments, by virtue of the important implications of the P-E Fit in the workplace, the P-E Fit may maintain a prominent position in industrial and organizational psychology and related fields. In some alternative embodiments, the P-E Fit may facilitate constructing or building a specific context comprising, or based on, one or more entities, namely the at least one of potential candidates and employees and one or more corresponding situations, and the interactions as well as interrelationships therebetween, thereby facilitating determining a most optimal match between the at least one of potential candidates and employees and corresponding environment dimensions, in accordance with the principles of the present invention. In some related embodiments, the P-E Fit may encompass a number of subsets, or sub-domains, for example, and in no way limiting the scope of the invention, the person-supervisor fit and Person-Job Fit (P-J Fit), which are conceptually distinct from one another. In some potential embodiments, the P-E Fit may lead to positive outcomes, such as satisfaction, performance, and overall well-being. In some alternative embodiments, the Person-Organization Fit (P-O Fit) may facilitate determining the compatibility between people and organizations, subject to fulfillment of one or more criterions, i.e. criteria, for example, and in no way limiting the scope of the invention, at least one of (a) one entity provides what the other entity needs, (b) both the entities share similar fundamental characteristics, and a combination thereof. In some related embodiments, high value congruence may serve as a large facet of the Person-Organization Fit (P-O Fit), which implies a strong culture and shared values among coworkers, thereby facilitating translating the high value congruence to increased levels of trust and a shared sense of corporate community. In some related embodiments, the foregoing high value congruence may facilitate in reaping benefits for a given organization, including reduced turnover, increased citizenship behaviors, and organizational commitment. In some illustrative embodiments involving implementation of the attraction-selection-attrition theory, the at least one of potential candidates and employees may be attracted to, and thus seek to work for organizations, where the at least one of potential candidates and employees may perceive high levels of the Person-Organization Fit (P-O Fit). In some related embodiments, a strong Person-Organization Fit (P-O Fit) may also lead to reduced turnover and increased organizational citizenship behaviors.

In some applicable embodiments involving implementation of the SOA-Based Optimal Candidate Search/Recommender-As-A-Service (SOAOCSRAAS) application software component in the context of the cloud computing based human talent management system, the SOAOCSRAAS application software component may facilitate assessing the P-E Fit via implementing one or more methods, namely at least one of direct, indirect measures, difference scores and profile correlation, polynomial regression, and one or more combinations thereof, in accordance with the principles of the present invention.

In some illustrative embodiments involving implementation of contributing theories comprising at least one of supplementary and complementary fit theories for the determination of the P-E Fit by the SOA-Based Optimal Candidate Search/Recommender-As-A-Service (SOAOCSRAAS) application software component in the context of the cloud computing based human talent management system, the supplementary fit may facilitate determining the similarity between the characteristics of at least one of potential candidates, employees, environment, other persons within the environment, and one or more combinations thereof. In some related embodiments, subject to the compatibility derived from the determined similarity, the at least one of potential candidates and employees may fit into a given environmental context by way of possession of one or more characteristics, which at least one of supplement, embellish, match and correspond with the characteristics of other individuals in the environment. In some alternative embodiments, the complementary fit may facilitate at least one of complementing, infilling and filling gaps between the characteristics of the at least one of potential candidates and employees and a given corresponding environment, thereby facilitating making a whole.

In some applicable embodiments involving implementation of the SOA-based Artificial Intelligence/Machine Learning-As-A-Service (SOAAIMLAAS) application software component, the SOAAIMLAAS application software component may facilitate rendering at least one of AI-, ML-based services, and a combination thereof, in accordance with the principles of the present invention.

In some operational embodiments, the SOAAIMLAAS application software component may facilitate recognizing patterns and regularities in data (or information) based on Machine Learning (ML), in accordance with the principles of the present invention. In some related embodiments, the SOAAIMLAAS application software component may be trained from labeled “training” data (supervised learning), however absent any labeled data other algorithms may be used to discover previously unknown patterns (unsupervised learning), in accordance with the principles of the present invention.

In some relevant embodiments involving implementation of supervised learning via deployment of the SOAAIMLAAS application software component, the supervised learning may facilitate implementation of the task of Machine Learning (ML) for inferring a function from labeled training data, wherein the training data may comprise at least one set of training examples. In some detailed embodiments involving implementation of supervised learning, each example of the at least one set of training examples may comprise at least one (input, output) pair consisting of an input object (typically a vector) and a desired output value (also called the supervisory signal). In some related embodiments, the supervised learning may facilitate analyzing the training data, thereby resulting in production of an inferred function, which may be used for mapping new examples.

In some detailed embodiments involving Machine Learning (ML), pattern recognition may facilitate assigning a label to a given input value. In some exemplary embodiments involving pattern recognition, for example, and in no way limiting the scope of the invention, classification may facilitate attempting assigning each input value to one of a given set of classes, for instance determining whether or not a given email is “spam” or “non-spam”. In some related embodiments, pattern recognition may be a relatively more general problem encompassing other types of output as well, for example, in no way limiting the scope of the invention, at least one of regression facilitating assigning a real-valued output to each input; sequence labeling facilitating assigning a class to each member of a sequence of values, for instance part of speech tagging, which assigns a part of speech to each word in an input sentence; and parsing, which assigns a parse tree to an input sentence, describing the syntactic structure of the sentence.

In some preferred embodiments, the SOAAIMLAAS application software component may facilitate recognizing patterns, in turn, facilitating the potential employers in analyzing the career path, and movements therein, of the potential candidates, in accordance with the principles of the present invention. In some related embodiments, the SOAAIMLAAS application software component may facilitate the potential employers in predicting the potential candidate fit for, or into, one or more projects of the potential employers, for instance at least one of mega, expansion, strategic, R&D, customer, continuity and improvement projects, the requirements and timelines thereof, subject to the historical movements or trends in the careers of the potential candidates, informing at least one of potential recruiters and employers in advance in connection with at least one of predetermined, expected, scheduled and tentative timings (or whereabouts) of the potential candidates, who may be at least one of currently and in future at least one of desirous, willing, expected, directed, forced, requested and required to as well as on the lookout; proposing one or more potential opportunities to the foregoing potential candidates; analyzing one or more offers made to the potential candidates in the past, and the responses thereto in terms of at least one of acceptation, acceptance and rejection, response behaviors and trends thereof; and predicting the likelihood of at least one of acceptation, acceptance and rejection of at least one of extended and proposed offers.

In some broad embodiments, the SOAAIMLAAS application software component may facilitate logically solving one or more issues in connection with the semantics of the contents of at least one of resumes, biodatas and Curriculum Vitae (CVs) of the pre-assessed (or potential) candidates, as drafted (or worded), uploaded and used by the pre-assessed (or potential) candidates, and transpiring by virtue of at one of uninformed, informed, unintentional and intentional usage of inter alia at least one of fanciful, arbitrary, suggestive, merely descriptive, semantically similar, semantically related, deceptively misdescriptive and misdescriptive, at least one of user-defined explicit, user-selected and user-preferred input words, terms, keywords and phrases, for example for Knowledge, Skills, and Abilities (KSA), Knowledge, Skills, Abilities and Other characteristics (KSAOs), for instance qualifications and occupations, in at least one of erroneous, correct, ambiguous, unambiguous, identifiable, unidentifiable, readable, unreadable, interpretable, uninterpretable, desirable, undesirable, predictable, unpredictable, contextual, non-contextual, strategic, non-strategic, chaotic, random and erratic way to at least one of declare, substitute, represent, define, describe, draw analogy and refer to at least one of optimal, desired, expected, required and mandatory reference words, terms, keywords and phrases, for example at least one of pre-defined, implicit, prescribed, unanimously-accepted, industry-specific words, terms, keywords and phrases for skills, competences, qualifications, occupations, as per one or more employment classifications, for instance International Standard Classification of Occupations (ISCO) of International Labor Organization (ILO), Standard Occupational Classification (SOC) System of US Government, European Skills, Competences, Qualifications and Occupations (ESCO), Historical International Standard of Classification of Occupations (HISCO), at least one of material and relevant to a given context of use, for instance submission of application by the potential candidates to, or before, the potential employers against at least one of job positions, offers and jobs, and the corresponding job descriptions, requirements, specifications, at least one of requested, required, expected, demanded and desired profiles, qualifications, experience, logistics, roles, responsibilities and skillset thereof, thereby leading to flaws in at least one of shortlisting and nomination of the potential candidates, subject to selection by way of elimination, in accordance with the principles of the present invention.

In some exemplary embodiments, for example, and in no way limiting the scope of the invention, the SOAAIMLAAS application software component may facilitate logically solving, for example based on at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), one or more semantic issues in connection with at least one of uninformed, informed, intentional and unintentional usage of at least one of fanciful, non-fanciful, arbitrary, non-arbitrary, suggestive, non-suggestive, merely descriptive, merely non-descriptive, descriptive, semantically similar, semantically dissimilar, semantically related, semantically unrelated, deceptively misdescriptive, deceptively descriptive, at least one of context-free, context-friendly, context-defined (implicit), contextual, non-contextual, context-dependent, context-independent, context-sensitive, context-based, context-insensitive, user-defined explicit, user-selected, user-preferred and out of context input words, keywords, terms and phrases, for example for Knowledge, Skills, and Abilities (KSA), Knowledge, Skills, Abilities and Other characteristics (KSAOs), for instance qualifications and occupations, for instance qualifications and occupations, in at least one of erroneous, correct, ambiguous, unambiguous, identifiable, unidentifiable, readable, unreadable, interpretable, uninterpretable, desirable, undesirable, predictable, unpredictable, contextual, non-contextual, strategic, non-strategic, chaotic, random and erratic way to at least one of declare, substitute, represent, define, describe, draw analogy and refer to at least one of optimal, desired, expected, required and mandatory reference words, terms, keywords and phrases, for example at least one of pre-defined, implicit, prescribed, unanimously-accepted, industry-specific words, terms, keywords and phrases for skills, competences, qualifications, occupations, as per one or more employment classifications, for instance International Standard Classification of Occupations (ISCO) of International Labor Organization (ILO), Standard Occupational Classification (SOC) System of US Government, European Skills, Competences, Qualifications and Occupations (ESCO), Historical International Standard of Classification of Occupations (HISCO), at least one of material and relevant to a given context of use, for instance submission of application by the potential candidates to, or before, the potential employers against at least one of job positions, offers and jobs, and the corresponding job descriptions, requirements, specifications, at least one of requested, required, expected, demanded and desired profiles, qualifications, experience, logistics, roles, responsibilities and skillset thereof, thereby leading to flaws in at least one of shortlisting and nomination of the potential candidates, subject to selection by way of elimination, in accordance with the principles of the present invention.

In some specialized embodiments, the SOAAIMLAAS application software component may comprise the SOA-based Lexical Analyzer (or Analysis)-As-A-Service (SOALAAAS) application software sub-component, SOA-based Syntax Analyzer (or Analysis)-As-A-Service (SOAS4XAAAS) application software sub-component and SOA-based Semantic Analyzer (or Analysis)-As-A-Service (SOAS6CAAAS) application software sub-component, thereby facilitating lexical, syntactic or syntax and semantic analyses of the contents of natural language documents, for instance the at least one of resumes, biodatas and Curriculum Vitae (CV) of the potential candidates, in accordance with the principles of the present invention.

In some operational embodiments involving deployment of the SOA-based Semantic Analyzer (or Analysis)-As-A-Service (SOAS6CAAAS) application software sub-component, the SOAS6CAAAS application software sub-component may facilitate semantic analysis of the contents of the at least one of resumes, biodatas and Curriculum Vitae (CV) as drafted (or worded) by the potential candidates, thereby facilitating semantically identifying, selecting and analyzing one or more of at least one of words and phrases at least one of material and relevant to a given context of use, for instance selection by way of elimination of the potential candidates by the potential employers against at least one of job positions, offers and jobs, and the corresponding job descriptions, requirements, specifications, at least one of requested, required, expected, demanded and desired profiles, qualifications, experience, logistics, roles, responsibilities and skillset thereof, in accordance with the principles of the present invention. p In some preferred embodiments, the SOAS6CAAAS application software sub-component may facilitate logically (or artificially intelligently) solving, for example based on at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI), one or more predominant issues in connection with semantics of the contents of at least one of resumes, biodatas and Curriculum Vitae (CVs) of the potential candidates as drafted (or worded), uploaded and used by the potential candidates, and comprising one or more of at least one of words and phrases at least one of immaterial and irrelevant to a given context of use, for instance selection by way of elimination of the potential candidates by the potential employers against at least one of job positions, offers and jobs, and the corresponding job descriptions, requirements, specifications, at least one of requested, required, expected, demanded and desired profiles, qualifications, experience, logistics, roles, responsibilities and skillset thereof, thereby leading to flaws in at least one of shortlisting and nomination of the potential candidates, subject to selection by way of elimination, in accordance with the principles of the present invention.

In some applicable embodiments involving deployment of the SOA-based Integrated Background Investigation and Verification-As-A-Service (SOAIBIVAAS) application software component in the context of the cloud computing based human talent management system, the SOAIBIVAAS application software component may facilitate at least one of investigating and verifying the background of the pre-assessed (or potential) candidates under pre-employment screening via implementation of one or more algorithms based on at least on of Artificial-Intelligence (AI), Machine-Learning (ML), and combinations thereof, for example Artificial Intelligence-based Machine Learning (AI-based ML)), Machine Learning-based Artificial Intelligence (ML-based AI), for instance Artificially Intelligent Machine Learning (AIML)-based algorithms, Machine Learning Artificial Intelligence (MLAI)-based algorithms, Machine Learning Artificially Intelligent (MLAI) algorithms, in accordance with the principles of the present invention. In some exemplary embodiments, for example, and in no way limiting the scope of the invention, the SOAIBIVAAS application software component may facilitate Artificial Intelligence (AI)-based (or Artificially Intelligent) and Machine Learning (ML)-based background investigation and verification or Machine-Learning (ML)-based Artificially Intelligent background investigation and verification, thereby facilitating at least one of relatively more ethical, secure, accurate, legitimate and consistent, as well as smart verification of the background of the at least one of potential candidates and employees with improved parameters of merit, namely maximized economic-feasibility, time efficiency and minimized manual intervention, in accordance with the principles of the present invention.

In some applicable embodiments involving deployment of the SOA-based Integrated Background Investigation and Verification-As-A-Service (SOAIBIVAAS) application software component in the context of the cloud computing based human talent management system, the SOAIBIVAAS application software component may facilitate pre-employment screening comprising investigating the backgrounds of potential employees to verify the accuracy of the claims made by pre-assessed or potential candidates as well as to discover any possible criminal history, worker's compensation claims, or employer sanctions via implementation of one or more algorithms based on at least on of Artificial-Intelligence (AI), Machine-Learning (ML), and combinations thereof, for example Artificial Intelligence-based Machine Learning (AI-based ML)), Machine Learning-based Artificial Intelligence (ML-based AI), for instance Artificially Intelligent Machine Learning (AIML)-based algorithms, Machine Learning Artificial Intelligence (MLAI)-based algorithms, Machine Learning Artificially Intelligent (MLAI) algorithms, in accordance with the principles of the present invention. In some exemplary embodiments, for example, and in no way limiting the scope of the invention, SOAIBIVAAS application software component may facilitate conducting one or more types of checks, namely at least one of academic verifications, character reference check, for instance criminal, arrest, incarceration, and sex offender records, gaps in employment history, citizenship, immigration, legal working status, litigation records, driving and vehicle records, drug tests, educational records, employment records, financial information, licensing records, medical, mental, and physiological evaluation and records, military records, polygraph testing, social security number, AADHAR ID, identity and address verification, for instance money laundering, identity, terrorist check and verification of the validity of passports, directorship, credit history and purchase fire arms, in accordance with the principles of the present invention.

In some advantageous embodiments involving implementation of the secure proprietary client-server SOAHTMAAS modular application software, the secure proprietary client-server SOAHTMAAS modular application software may facilitate at least one of emulating and simulating the real-time experience of interviews conducted by the third-party Subject Matter Experts (SMEs) and hosted by the one or more host (or hosting) service(s) aggregators, thereby facilitating building confidence, prior to actual exposure of the potential candidates to the corporate environments, in accordance with the principles of the present invention.

In some advantageous embodiments involving implementation of the secure proprietary client-server SOAHTMAAS modular application software, the secure proprietary client-server SOAHTMAAS modular application software may facilitate providing a secure audio-video interview platform for corporates for hosting live interviews of the potential candidates with at least one of online text chat, synchronous and asynchronous conferencing, for instance audio conferencing, video conferencing, web conferencing, multimedia conferencing, Interactive Whiteboard (IWB), and coding panel facility, in accordance with the principles of the present invention.

In some advantageous embodiments involving implementation of the secure proprietary client-server SOAHTMAAS modular application software, the secure proprietary client-server SOAHTMAAS modular application software may facilitate the potential employers in posting asynchronous online coding challenges and interview questions to the potential candidates and get instant responses, in accordance with the principles of the present invention.

In some advantageous embodiments involving implementation of the secure proprietary client-server SOAHTMAAS modular application software, the secure proprietary client-server SOAHTMAAS modular application software may facilitate at least one of reviewing, evaluating and rating any and all employment interview data or information provided by the potential employers for sharing across concerned stakeholders, at least one of actively and passively involved in the processes of selecting, hiring and recruiting the potential candidates, with recorded videos, thereby facilitating unbiased hiring, in accordance with the principles of the present invention.

In some advantageous embodiments involving implementation of the secure proprietary client-server SOAHTMAAS modular application software, the secure proprietary client-server SOAHTMAAS modular application software may facilitate reporting background verification of the potential candidates upon demand, in turn, facilitating executing preventive mechanisms against potential risks and fraud, in accordance with the principles of the present invention.

In some advantageous embodiments, the secure proprietary client-server SOAHTMAAS modular application software may facilitate pre-assessing the potential jobseekers through crowdsourced 3PSMEs or industry experts, in accordance with the principles of the present invention.

In some advantageous embodiments, the secure proprietary client-server SOAHTMAAS modular application software may facilitate at least one of adaptively and dynamically capturing requirements of at least one of potential employers and candidates, specifying the captured requirements, subjecting the specified requirements to one or more feasibility analyses, for example, at least one of technical, economical and operational feasibility analysis, and combinations thereof, profiling the specified requirements based on the results of the analyses of the specified requirements, categorizing the specified requirements based on the corresponding profiles thereof, recommending one or more at least most optimal, relevant and best solutions comprising at least one of most optimal, relevant and best resources, for example technologies, human resources, operating environments, whenever and wherever required, for instance the right resources, at the right place and at the right time, and tracking efficacy of the recommendations made, in accordance with the principles of the present invention.

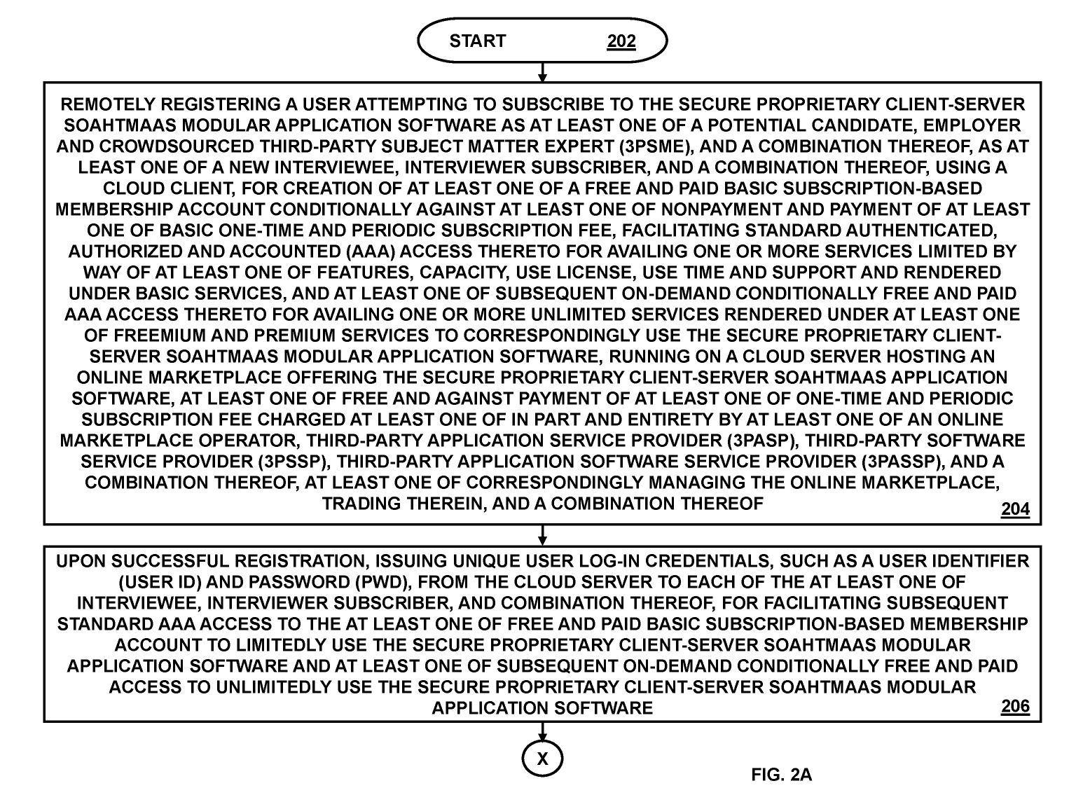

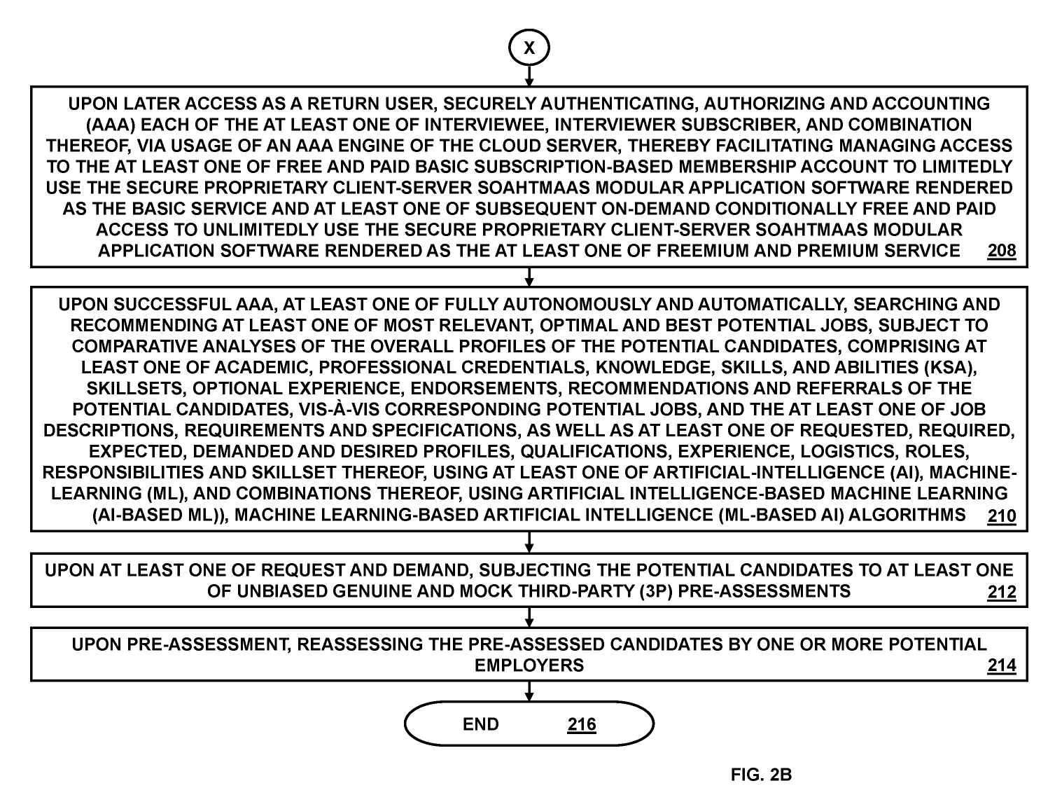

FIGS. 2A-2B depicts the method for rendering Human Talent Management-As-A-Service (HTMAAS) in cloud computing based human talent management system, according to one or more embodiments.

In some preferred embodiments, as depicted in FIG. 2, and with reference to FIG. 1, a method 200 of the present invention facilitates subscription-based licensing and delivery of a secure proprietary client-server Service-Oriented Architecture-based Human Talent Management-As-A-Service (SOAHTMAAS) modular application software, for instance the secure proprietary client-server SOAHTMAAS modular application software 128 of FIG. 1, for rendering human talent management services, in accordance with the principles of the present invention.

The method 200 starts at step 202 and proceeds to step 204.

At step 204, the method 200 may facilitate, or comprise, remotely registering at least a user attempting to subscribe to the secure proprietary client-server SOAHTMAAS modular application software 128 as at least one of a potential candidate, employer and crowdsourced Third-Party Subject Matter Expert (3PSME), and a combination thereof, as at least one of a new interviewee, interviewer subscriber, and a combination thereof, using at least a cloud client, for instance the cloud client 104, for creation of at least one of a free and paid basic subscription-based membership account conditionally against at least one of nonpayment and payment of at least one of basic one-time and periodic subscription fee, facilitating standard Authenticated, Authorized and Accounted (AAA) access thereto for availing one or more services limited by way of at least one of features, capacity, use license, use time and support and rendered under basic services, and at least one of subsequent on-demand conditionally free and paid AAA access thereto for availing one or more unlimited services rendered under at least one of freemium and premium services to correspondingly use the secure proprietary client-server SOAHTMAAS modular application software 128, running on a cloud server, for instance the human talent management (or control) cloud server 102, hosting an online marketplace offering the secure proprietary client-server SOAHTMAAS modular application software 128, at least one of free and against payment of at least one of one-time and periodic subscription fee charged at least one of in part and entirety by at least one of an online marketplace operator, Third-Party Application Service Provider (3PASP), Third-Party Software Service Provider (3PSSP), Third-Party Application Software Service Provider (3PASSP), and a combination thereof, at least one of correspondingly managing the online marketplace, trading therein, and a combination thereof.

At step 206, the method 200 may facilitate, or comprise, upon successful registration, issuing unique user log-in credentials, such as a User Identifier (User ID) and Password (PWD), from the human talent management (or control)cloud server 102 to each of the at least one of interviewee, interviewer subscriber, and combination thereof, for facilitating subsequent standard AAA access to the at least one of free and paid basic subscription-based membership account to limitedly use the secure proprietary client-server SOAHTMAAS modular application software 128 and at least one of subsequent on-demand conditionally free and paid access to unlimitedly use the secure proprietary client-server SOAHTMAAS modular application software 128.

At step 208, the method 200 may facilitate, or comprise, upon later access as a return user, securely Authenticating, Authorizing and Accounting (AAA) each of the at least one of interviewee, interviewer subscriber, and combination thereof, via usage of an AAA engine of the cloud server, thereby facilitating managing access to the at least one of free and paid basic subscription-based membership account to limitedly use the secure proprietary client-server SOAHTMAAS modular application software 128 rendered as the basic service and at least one of subsequent on-demand conditionally free and paid access to unlimitedly use the secure proprietary client-server SOAHTMAAS modular application software 128 rendered as the at least one of freemium and premium service.

At step 210, the method 200 may facilitate, or comprise, upon successful AAA, at least one of fully autonomously and automatcially, searching and recommending at least one of most relevant, optimal and best potential jobs, subject to comparative analyses of the overall profiles of the potential candidates, comprising at least one of academic, professional credentials, Knowledge, Skills, and Abilities (KSA), skillsets, optimal experience, endorsements, recommendations and referrals of the potential candidates, vis-à-vis corresponding potential jobs, and the at least one of job descriptions, requirements and specifications, as well as at least one of requested, required, expected, demanded and desired profiles, qualifications, experience, logistics, roles, responsibilities and skillset thereof, using at least one of Artificial-Intelligence (AI), Machine-Learning (ML), and combinations thereof, for instance via implementation of the SOA-Based Optimal Job Search/Recommender-As-Service (SOAOJSRAAS) sub-component 128B18 using Artificial Intelligence-based Machine Learning (AI-based ML)), Machine Learning-based Artificial Intelligence (ML-based AI) algorithms, in accordance with the principles of the present invention.

At step 212, the method 200 may facilitate, or comprise, upon at least one of request and demand, subjecting the potential candidates to at least one of unbiased genuine and mock Third-Party (3P) pre-assessments. In some operational embodiments, the step of subjecting the potential candidates to at least one of unbiased genuine and mock Third-Party (3P) pre-assessments may comprise at least one of partially manually, autonomously and automatically, searching and recommending at least one of most relevant, optimal and best potential 3PSMEs based partly on the analyses of the at least one of i) the overall profiles of the potential 3PSMEs, comprising at least one of academic, professional credentials, Knowledge, Skills, and Abilities (KSA), skillsets, experience, ratings, feedbacks, comments, reviews, endorsements, recommendations and referrals of the potential 3PSMEs, ii) the overall profiles of the potential candidates, and the degree of match therebetween, for instance 3PSME-candidate fit most strongly related to 3PSME-oriented outcomes like 3PSME satisfaction, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI) algorithms, in accordance with the principles of the present invention.

In some related embodiments, the step of subjecting the potential candidates to at least one of unbiased genuine and mock Third-Party (3P) pre-assessments may further comprise at least one of partially manually, autonomously and automatically pre-assessing assessing the potential candidates, and combinations thereof, comprising pre-assessing the potential candidates, and combinations thereof, may further comprise pre-assessing the potential candidates via at least one of i) implementation of at least one of AI- and ML-based chatbots, and a combination thereof, for instance the SOA-based Chatbot-As-A-Service (SOACAAS) application software sub-component 128B10, and ii) at least one of partially manually selected, AI-, ML-searched-cum-recommended at least one of most optimal and best 3PSMEs, and a combination thereof, wherein the pre-assessment of the potential candidates via selectively engaging the at least one of partially manually selected, AI-, ML-searched-cum-recommended at least one of most optimal and best 3PSMEs, and combination thereof, comprises at least one of ethically, permissibly, selectively securely, accurately, legitimately and legibly capturing, recording, archiving and storing the contents of the at least one of partially manual, AI-, ML-based pre-assessment of the potential candidates, for instance at least one of offline face-to-face and online unbiased mock job interviews, by the 3PSMEs for subsequent use and reuse, whilst maintaining the at least one of pseudonymity and anonymity of the 3PSMEs, whereas the pre-assessment of the potential candidates via the implementation of the at least one of AI- and ML-based chatbots, and combination thereof, comprises analyzing the potential jobs, and the at least one of job descriptions, requirements and specifications, as well as at least one of requested, required, expected, demanded and desired profiles, qualifications, experience, logistics, roles, responsibilities and skillset thereof, posting questionnaires to the potential candidates, at least one of ethically, permissibly, selectively securely, accurately, legitimately and legibly capturing, recording, archiving, storing and processing the responses of the potential candidates using at least one of Artificial Intelligence (AI)-, Machine-Learning (ML)-based algorithms, and a combination thereof, searching and recommending at least one of most optimal and best responses to the questionnaires and the corresponding respondents, for instance the one or more pre-assessed candidates using at least one of AI-, ML-based search-cum-recommendation, and a combination thereof, at least one of adaptively and dynamically, at least one of iteratively reviewing and rating the pre-assessed candidates and adding the at least one of posted questionnaires, processed recorded responses, corresponding respondents thereto, and the reviews as well as ratings thereof.

At step 214, the method 200 may facilitate, or comprise, upon pre-assessment, reassessing the pre-assessed candidates by one or more potential employers comprising at least one of partially manually, autonomously and automatically, searching and recommending at least one of most relevant, optimal and best pre-assessed candidates for the at least one of most optimal, relevant and best potential jobs comprising at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers, at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers, at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers, and at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween, in accordance with the principles of the present invention.

The method 200 ends at step 216.

### Example Computer System

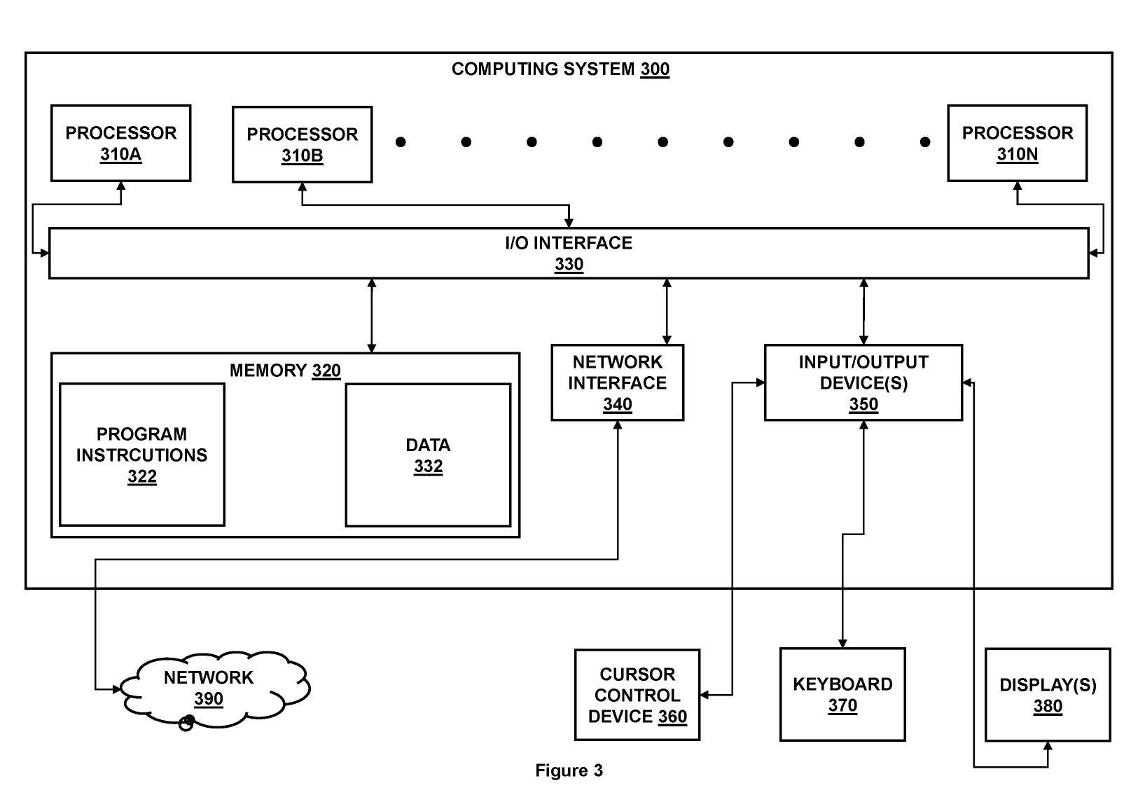

FIG. 3 depicts a computer system that may be a computing device and may be utilized in various embodiments of the present invention.

Various embodiments of the method for rendering Human Talent Management-As-A-Service (HTMAAS) in cloud computing based human talent management system 100, of FIG. 1, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement one or more methods described above. The computer system 300 may be used to implement any other system, device, element, functionality or method of the above-described embodiments. In the illustrated embodiments, computer system 300 may be configured to implement one or more methods as processor-executable executable program instructions 322 (e.g., program instructions executable by processor(s) 310A-N) in various embodiments.

In the illustrated embodiment, computer system 300 includes one or more processors 310A-N coupled to a system memory 320 via an input/output (I/O) interface 330. The computer system 300 further includes a network interface 340 coupled to I/O interface 330, and one or more input/output devices 350, such as cursor control device 360, keyboard 370, and display(s) 380. In various embodiments, any of components may be utilized by the system to receive user input described above. In various embodiments, a user interface (e.g., user interface) may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310A-N may be any suitable processor capable of executing instructions. For example, in various embodiments processors 310 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 310A-N may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one components (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. AIso, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. AIternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implanted method facilitating subscription-based licensing and delivery of a secure proprietary client-server Service-Oriented Architecture-based Human Talent Management-As-A-Service (SOAHTMAAS) modular application software for rendering human talent management services, the method comprising:
remotely registering at least a user attempting to subscribe to the secure proprietary client-server SOAHTMAAS modular application software as at least one of a potential candidate, employer and crowdsourced Third-Party Subject Matter Expert (3PSME), and a combination thereof, as at least one of a new interviewee, interviewer subscriber, and a combination thereof, using at least a cloud client, for creation of at least one of a free and paid basic subscription-based membership account conditionally against at least one of nonpayment and payment of at least one of basic one-time and periodic subscription fee, facilitating standard Authenticated, Authorized and Accounted (AAA) access thereto for availing one or more services limited by way of at least one of features, capacity, use license, use time and support and rendered under basic services, and at least one of subsequent on-demand conditionally free and paid AAA access thereto for availing one or more unlimited services rendered under at least one of freemium and premium services to correspondingly use the secure proprietary client-server SOAHTMAAS modular application software, running on a cloud server hosting an online marketplace offering the secure proprietary client-server SOAHTMAAS modular application software, at least one of free and against payment of at least one of one-time and periodic subscription fee charged at least one of in part and entirety by at least one of an online marketplace operator, Third-Party Application Service Provider (3PASP), Third-Party Software Service Provider (3PSSP), Third-Party Application Software Service Provider (3PASSP), and a combination thereof, at least one of correspondingly managing the online marketplace, trading therein, and a combination thereof;
upon successful registration, issuing unique user log-in credentials, such as a User Identifier (User ID) and Password (PWD), from the cloud server to each of the at least one of interviewee, interviewer subscriber, and combination thereof, for facilitating subsequent standard AAA access to the at least one of free and paid basic subscription-based membership account to limitedly use the secure proprietary client-server SOAHTMAAS application software and at least one of subsequent on-demand conditionally free and paid access to unlimitedly use the secure proprietary client-server SOAHTMAAS modular application software;
upon later access as a return user, securely Authenticating, Authorizing and Accounting (AAA) each of the at least one of interviewee, interviewer subscriber, and combination thereof, via usage of an AAA engine of the cloud server, thereby facilitating managing access to the at least one of basic access and minimal service subscription-based account rendered as the basic service and at least one of subsequent conditionally free and paid access to use the secure proprietary client-server HTMAAS application software rendered as the at least one of freemium and premium service;
upon successful AAA, at least one of fully autonomously and automatically, searching and recommending at least one of most relevant, optimal and best potential jobs, subject to comparative analyses of the overall profiles of the potential candidates, comprising at least one of academic, professional credentials, Knowledge, Skills, and Abilities (KSA), skillsets, optional experience, endorsements, recommendations and referrals of the potential candidates, vis-à-vis corresponding potential jobs, and the at least one of job descriptions, requirements and specifications, as well as at least one of requested, required, expected, demanded and desired profiles, qualifications, experience, logistics, roles, responsibilities and skillset thereof, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI);
upon at least one of request and demand, subjecting the potential candidates to at least one of unbiased genuine and mock Third-Party (3P) pre-assessments comprising:
at least one of partially manually, autonomously and automatically, searching and recommending at least one of most relevant, optimal and best potential 3PSMEs based partly on the analyses of the at least one of i) the overall profiles of the potential 3PSMEs comprising at least one of academic, professional credentials, Knowledge, Skills, and Abilities (KSA), skillsets, experience, ratings, feedbacks, comments, reviews, endorsements, recommendations and referrals of the potential 3PSMEs, ii) the overall profiles of the potential candidates, and the degree of match therebetween, for instance 3PSME-candidate fit most strongly related to 3PSME-oriented outcomes like 3PSME satisfaction, using at least one of Artificial-Intelligence (AI), Machine-Learning (ML), and combinations thereof, for instance Artificial Intelligence-based Machine Learning (AI-based ML)), Machine Learning-based Artificial Intelligence (ML-based AI),
at least one of partially manually, autonomously and automatically pre-assessing the potential candidates, and combinations thereof, comprising:
pre-assessing the potential candidates via at least one of i) implementation of at least one of AI- and ML-based chatbots, and a combination thereof, and ii) at least one of partially manually selected, AI-, ML-searched-cum-recommended at least one of most optimal and best 3PSMEs, and a combination thereof,
wherein the pre-assessment of the potential candidates via selectively engaging the at least one of partially manually selected, AI-, ML-searched-cum-recommended at least one of most optimal and best 3PSMEs, and combination thereof, comprising at least one of ethically, permissibly, selectively securely, accurately, legitimately and legibly capturing, recording, archiving and storing the contents of the at least one of partially manual, AI-, ML-based pre-assessment of the potential candidates, for instance at least one of offline face-to-face and online unbiased mock job interviews, by the 3PSMEs for subsequent use and reuse, whilst maintaining the at least one of pseudonymity and anonymity of the 3PSMEs,
whereas the pre-assessment of the potential candidates via the implementation of the at least one of AI- and ML-based chatbots, and combination thereof, comprises analyzing the potential jobs, and the at least one of job descriptions, requirements and specifications, as well as at least one of requested, required, expected, demanded and desired profiles, qualifications, experience, logistics, roles, responsibilities and skillset thereof, posting questionnaires to the potential candidates, at least one of ethically, permissibly, selectively securely, accurately, legitimately and legibly capturing, recording, archiving, storing and processing the responses of the potential candidates using at least one of Artificial Intelligence (AI)-, Machine-Learning (ML)-based algorithms, and a combination thereof, searching and recommending at least one of most optimal and best responses to the questionnaires and the corresponding respondents, for instance the one or more pre-assessed candidates using at least one of AI-, ML-based search-cum-recommendation, and a combination thereof, at least one of adaptively and dynamically, at least one of iteratively reviewing and rating the pre-assessed candidates and adding the at least one of posted questionnaires, processed recorded responses, corresponding respondents thereto, and the reviews as well as ratings thereof; and
upon pre-assessment, reassessing the pre-assessed candidates by one or more potential employers comprising:
at least one of partially manually, autonomously and automatically, searching and recommending at least one of most relevant, optimal and best pre-assessed candidates for the at least one of most optimal, relevant and best potential jobs comprising:
at least one of AI-, ML-based logical resolution of one or more issues in connection with the semantics of the contents of the resumes, biodatas and Curriculum Vitae (CVs) of the pre-assessed candidates, thereby facilitating at least one of shortlisting and nomination of the pre-assessed candidates, subject to selection by way of elimination, for one or more interviews or assessments by the potential employers,
at least one of AI-, ML-based facial (or face) detection, recognition and perception of the pre-assessed candidates, and combinations thereof, thereby facilitating avoiding impersonation by the selected pre-assessed candidates during the one or more interviews or assessments by the potential employers,
at least one of AI-, ML-based search-cum-recommendation of at least one of most optimal and best responses to questionnaires and the corresponding respondents thereto, and combinations thereof, for instance the one or more selected pre-assessed candidates subjected to the one or more interviews (or assessments) by the potential employers, and
at least one of AI-, ML-based background investigation and verification of the interviewed candidates, thereby facilitating expediting final hiring and onboarding of the interviewed candidates, in turn, facilitating at least one of minimizing and reducing the at least one of time-to-hire, cost-to-hire, labor-to-hire, and a combination thereof, whilst managing optimal trade-off therebetween.

2. The method of claim 1, wherein the online marketplace is a cloud marketplace hosted and managed by the at least one of online marketplace operator, 3PASP, and combination thereof, and wherein the online marketplace operator is the 3PASP or vice-versa.

3. The method of claim 1, wherein the step of at least one of partially manually, autonomously and automatically, searching and recommending at least one of most relevant, optimal and best pre-assessed candidates for the at least one of most optimal, relevant and best potential jobs further comprising:
lexically analyzing the contents of natural language documents, for instance the at least one of resumes, biodatas and Curriculum Vitae (CV) of the potential candidates, thereby facilitating converting a sequence of characters of the contents of the natural language documents into a sequence of words each with an assigned and identified meaning in the context of corresponding given natural languages used for the corresponding natural language documents,
syntactically analyzing the sequence of words each with the assigned and identified meaning in the context of the corresponding natural languages used for the natural language documents to determine conformance of the words to corresponding sets of the rules of corresponding grammars of the corresponding given natural languages used for the corresponding natural language documents, and
semantically analyzing the contents of natural language documents, for instance the at least one of resumes, biodatas and Curriculum Vitae (CV) of the potential candidates, for relating one or more syntactic structures from the levels of phrases, clauses, sentences and paragraphs to the level of the writing as a whole, to at least one of corresponding natural language-dependent and language-independent meanings therefor, thereby facilitating semantically identifying, selecting and analyzing one or more of at least one of words and phrases at least one of material and relevant to a given context of use, for instance selection by way of elimination of the potential candidates by the potential employers against at least one of job positions, offers and jobs, and the corresponding job descriptions, requirements, specifications, at least one of requested, required, expected, demanded and desired profiles, qualifications, experience, logistics, roles, responsibilities and skillset thereof.

4. The method of claim 1, wherein the step of pre-assessing the potential candidates via at least one of i) implementation of at least one of AI- and ML-based chatbots, and a combination thereof, further comprises:
comparative analyses of the potential jobs, and the at least one of job descriptions, requirements and specifications, as well as at least one of requested, required, expected, demanded and desired profiles, qualifications, experience, logistics, roles, responsibilities and skillset thereof, vis-à-vis the overall profiles of the potential candidates, comprising at least one of academic, professional credentials, Knowledge, Skills, and Abilities (KSA), skillsets, optimal experience, endorsements, recommendations and referrals of the potential candidates, using at least one of Artificial-Intelligence (AI), Machine-Learning (ML), Natural Language Processing (NLP), and combinations thereof, wherein the recordings of pre-assessments conducted by the 3PSMEs is used as the training data for the at least one of AI- and ML-based chatbots, and combinations thereof, interview bots.
